(19) United States
(12) Patent Application Publication
(10) Pub. No.: US 2013/0212974 A1
(43) Pub. Date: Aug. 22, 2013

(54) INTERLOCKING REINFORCEMENT INCLUSIONS USABLE IN ULTRA-HIGH PERFORMANCE CONCRETE AND OTHER APPLICATIONS, IMPROVED UHPC MATERIAL AND METHOD OF MAKING SAME

(71) Applicant: John T. Sullivan, Marriottsville, MD (US)

(72) Inventor: John T. Sullivan, Marriottsville, MD (US)

(73) Assignee: John T. Sullivan, Marriottsville, MD (US)

(21) Appl. No.: 13/401,435

(22) Filed: Feb. 21, 2012

(51) Int. Cl. E04C 1/00; E02D 17/20; B29C 39/42; E04C 5/00

(52) U.S. Cl. 52/659; 52/677; 52/676; 405/302.6; 264/101

(57) ABSTRACT

A concrete casting method uses a vacuum to remove air from the concrete material, and further involves pouring the cement material over three-dimensional interlocking inclusions before curing. The inclusions may be generally polyhedral structures formed by an annular or disc-shaped central structure that defines a parting plane for an injection mold, and various structures extending transversely to the central annular or disc-shaped structure to form the generally polyhedral shape. Alternatively, the inclusions may be formed by a hub and radial structures, from which extend circumferential structures that define the polyhedral shape. Other inclusion structures take the form of wires or tubes with multiple coils. The inclusions may be used in a variety of concrete structures, including earthquake or tornado proof housing structures, cylindrical supports structures, and armored structure including ships and submarines.

### BACKGROUND OF THE INVENTION

1. Field of the Invention

This invention relates to interlocking reinforcement inclusions for ultra-high performance concrete (UHPC) and other inclusion-containing materials, and also for other applications such as soil erosion prevention and beach or shoreline stabilization and protection.

The invention also relates to an improved UHPC and other materials having inclusions, to structures made of the improved materials, and to a method of making concrete structures that utilizes vacuum curing.

2. Description of Related Art

Reinforcement inclusions are objects that are placed within another material to increase the strength or durability of the material. For example, the addition of sand and gravel to cement results in concrete, a material having a substantially higher durability, flexural strength, and compressive strength than plain cement. The durability of ordinary concrete is evidenced by the fact that many ancient Roman concrete structures have lasted for two millennia.

Although normal-strength concrete, which typically displays compressive strengths of between 3 and 5 ksi (thousands of pounds per square inch), there is a need for even stronger types of concrete continues, as engineers seek to employ smaller and more durable concrete in structures. Replacing normal-strength concrete in many applications is high-performance concrete (HPC), which uses embedded steel reinforcement and typically achieves compressive strengths of 10 to 12 ksi. However, concerns about HPC's relatively low strength-to-weight ratio, low ductility and tensile strength, and objectionable volume instability, leaves most concretes used today with much room for improvement.

Much of the problems with HPC have been solved with the advent of ultra-high performance concrete (UHPC, often referred to as Reactive Powder Concrete, or RPC), which differs from conventional concrete in the addition of fine quartz, simple steel fiber inclusions (e.g., 0.008 diameter×−0.5 inch length, and a superplasticizer. In addition or alternatively to steel fibers, UHPC inclusions may take the form of nanotubes, dove-tailed plastic fibers, and PVA or cellulose fibers, including fibers made of plastic waste materials. UHPC is capable of achieving compressive strengths greater than 150 MPa (21.7 ksi). In addition, UHPC is nearly impermeable, an advantage that confers resistance against many destructive processes that degrade NSC and HPC, including freeze-thaw, corrosion of embedded steel, and solvation by chemicals that penetrate into the concrete.

Most reinforcement inclusions are intended to provide an “anchoring” effect that holds the concrete together even when it has yielded and cracked. However, the material can also lend its own compressive-strength properties to the concrete. The anchoring effect may be achieved by 1) friction or traction between the surfaces of the inclusion and the concrete components, 2) enclosure of concrete components by surfaces of the inclusion; and 3) chemical bonding between the inclusion surfaces and the surrounding matrix. Anchorage failure of steel reinforcement inclusions can be classified into four categories: 1) pull through; 2) concrete breakout; 3) splitting; and 3) steel failure. By far, the most prevalently used inclusions are steel fibers of various compositions, dimensions, and geometries. Such fibers share an elongated wire-like shape, but can have a variety of different cross-sections, as well as bends, hooks, or twists.

Notwithstanding the proven advantages of UHPC, the process requirements tend to be considerably more expensive than those required for other types of concrete. One of the contributors to the high cost of current UHPC is the requirement of a thermal curing step, which is in addition to the mixing and casting steps of conventional concrete. A typical thermal treatment consists of 48 hr steaming at 194° F. and 100% relative humidity reached through a ramp-up period (e.g., 6 hrs). A ramp-down period of about the same duration of the ramp-up follows thermal treatment. Upon completion of the curing process the concrete is allowed to return to room temperature. Other thermal regimens, including delayed and doubly-delayed thermal treatment, are also known, but all add significantly to the cost of UHPC applications.

In addition to higher processing costs, the inclusions typically used in UHPC add substantially to the cost, and especially those made of metal, such as steel fibers. Moreover, use of steel or plastic fibers as reinforcement inclusions has a number of additional disadvantages. First, when the concrete is poured, the fibers align themselves with the direction of flow, resulting in differences in compressive and tensile strength properties along different axes. Second, whether steel or plastic the fibers tend to clump during pouring and mixing. Third, UHPC with fiber inclusions may explode during thermal treatment because steam cannot escape the concrete due to its relatively high density. Fourth, when used in structures that must be protected from bombs or artillery, an explosion will eject the fibers out of the concrete upon impact, causing failure of the concrete.

An additional problem occurs with both conventional concrete and UHPC, in which inclusions can cause back up at twists or turns in the hose through which the concrete is pumped, with the resulting back pressure causing a possible blow out, waste of material, and injury to the operator.

Some of these problems have been addressed by replacing the conventional wire inclusions with three dimensional structures. A number of different examples of such three-dimensional inclusion structures are disclosed in U.S. Patent Publication No. 2011/0101266, and also in U.S. Pat. Nos. 5,404,688, 3,913,295, and 3,616,589. The structures are formed of regular wires, or wires/fibers with irregular or non-circular cross-sections, into a variety of regular and irregular three-dimensional polyhedrons or other geometric shapes having edges defined by the wires, as well as loop structures, coils having ends bonded together, and even DNA-like double helixes. These open geometric shapes are said to provide an interlocking effect in that, when packed tightly together, portions of the structures will penetrate into openings adjacent structures, there providing a “skeletal network of reinforcement to improve composite toughness and help prevent cracking or crack propagation” (paragraph [0134]). However, these shapes are difficult to form in that they require bonding of individual wires to form the three dimensional structures or loops. In addition, the shapes lack sufficient structure to improve the compressive strength of the concrete material to which they are added.

Yet another example of spherical inclusions is described in the publication by Guomundur Bjornson entitled “BubbleDeck Two-Way Hollow Deck” (www.bubbledeck.com, September 2003), which involved placement of tightly pack hollow spheres or balls between two layers of concrete reinforcement mesh. While displacing concrete materials and thereby lowering cost, and also achieving a degree of isotropy, the hollow balls used in the bubble deck do not provide any added strength.

An alternative approach is taken in U.S. Pat. No. 5,145,285, which discloses molded high density polypropylene concrete or soil inclusions made of arms or spokes extending from a central hub, and formed with polyhedral structures at the ends of the arms. The overall shapes of the inclusions are similar to those of a children's “jacks” game. These complex shapes are difficult to manufacture, and lack the interlockability and compressibility of structures with a generally polyhedral shape.

The present invention also provides three-dimensional interlocking inclusions, but offers several advantages over the inclusions described in U.S. Patent Publication No. 2011/0101266 and U.S. Pat. Nos. 5,404,688, 5,145,285, 3,913,295, and 3,616,589. Like the inclusions of U.S. Pat. No. 5,145,285, and unlike those of the other cited publications, the inclusions may be made of an inexpensive plastic material and yet are adapted for simple molding procedures that do not require insertion rods or multiple molding steps. Second, even though the inclusions have generally polyhedral shapes and openings or voids that allow interlocking, as with U.S. Patent Publication No. 2011/0101266 and, for example, U.S. Pat. No. 3,913,295 (and that can enclose sections of the cement or other material poured around, and leave space for venting excess steam to prevent explosions during curing), they also include axial or internal structures that add rigidity, while still permitting a degree of compression, so as to increase the compressive strength of the resulting concrete. This can be especially useful in creating inexpensive earthquake or tornado-proof concrete structures. Third, the inclusions can be formed with additional structures such as hooks or knobs to enhance the interlocking effect, without substantially increasing cost. Fourth, in an alternative embodiment, the inclusions can be made of wire coils that, when subject to a pulling force, tighten to increase resistance to ejection from the concrete material when subject to an explosion or extremely high force.

Additional three-dimensional or fiber inclusions are disclosed in U.S. Patent Publication Nos. 2010/0065491; 2009/0169885; 2008/0145580; 2006/0106191; and 2004/0217505, and U.S. Pat. Nos. 7,749,352; 6,706,380; 6,054,086; 6,045,911; 5,981,650; 5,419,965; 5,145,285; 4,628,001; 4,610,926; 4,585,487; 3,913,295; 3,846,085; 3,616,589; 3,400,507; 2,677,955; 1,913,707; 1,976,832; 1,594,402; and 1,349,901. Of these, U.S. Pat. No. 2,677,955 is of particular interest for its disclosure of fiber inclusions that are formed into single loops. The present invention includes inclusions made of multiple loops.

Byway of further background, U.S. Pat. No. 5,556,229 discloses the use of spherical inclusion-like structures for shoreline erosion control, while U.S. Patent Publication discloses the use of interlocking structures for “rubble mound structures” such as breakwaters. The present invention also has applicability to shoreline erosion prevention and rubble mound like structures.

### SUMMARY OF THE INVENTION

It is accordingly a first objective of the invention to solve one or more of the above-described problems and disadvantages of conventional UHPC and other inclusion-containing materials such as, by way of example and not limitation, conventional concrete and resin or fiberglass materials.

It is a second objective of the invention to provide a UHPC material having a reduced cost.

It is a third objective of the invention to provide an improved method of casting structures made of UHPC and other concrete materials.

It is a fourth objective of the invention to provide UHPC and concrete materials, as well as other inclusion-containing materials, having improved structural integrity.

It is a fifth objective of the invention to provide low cost inclusions for UHPC and other inclusion-containing materials, as well as for reducing soil or shoreline erosion and similar applications.

It is a sixth objective of the invention to provide inclusions that increase the strength of UHPC or other inclusion-containing materials, either isotropically or anisotropically.

It is a seventh objective of the invention to provide UHPC or concrete structures, or structures made of other inclusion-containing materials, having increased resistance to damage from impacts, explosions, earthquakes, tornados, and other external forces.

It is an eighth objective of the invention to provide a UHPC or other concrete material that offers improved safety during pouring and/or curing.

These objectives of the invention are achieved, according to a preferred embodiment of the invention, by providing a concrete casting method that replaces the conventional use of steam for thermal treatment with vacuum curing, for example by placing a bag over the poured concrete and applying a vacuum to the bag. The use of vacuum curing greatly simplifies casting processes that would otherwise require heat treatment, such as UHPC casting processes, by rapidly drawing moisture out of the concrete while minimizing the risk of explosion due to steam trapped in the concrete. When inclusions of the type described herein are used, the open structure of the inclusions allows moisture to pass, expediting the curing process and decreasing the risk of problems caused by pressure build-up from trapped steam, although the vacuum curing method of the invention may also advantageously be applied to UHPC and other concrete materials that utilize inclusions other than those specifically described herein.

According to the principles of various preferred embodiments of the invention, conventional fiber inclusions are replaced by inclusions in the form of three dimensional structures having a generally polyhedral shape formed by an annular or disc-shaped central structure that defines a parting plane for an injection mold, and various structures extending transversely to the central annular or disc-shaped structure to form the generally polyhedral shape. Alternatively, the inclusions may be formed by a hub and radial structures, from which extend circumferential structures that define the polyhedral shape. Other preferred inclusion structures take the form of wires or tubes with multiple coils. Preferably, the inclusions are designed to be molded in simple two part molds without the need for movable rods or pins to form, but the invention also encompasses inclusions that require use of rods or pins, or other additional forming steps.

In addition to the basic structures described above, the inclusions of the preferred embodiments may have one or more the following features or advantages:
a. The inclusions can be designed so that they do not align along a preferred axis during cast, making the resulting cast material isotropic, or the inclusions can be designed to have different properties in different directions and/or to self-align with respect to the direction of pouring of a cement material;
b. If the inclusions are isotropic, the inclusions can roll and flow in any direction during pouring and mixing of the cast material, eliminating clumping;
c. The voids in the inclusions accommodate excess steam, preventing the concrete from exploding during curing;
d. The inclusions can be tethered to looped wires, preventing the inclusions from being ejected upon an impact or explosion; and
e. The voids in the inclusions enable material to pass through the inclusions and avoid backing up at bends in a hose during pouring, preventing hazards to the operator and pouring/casting equipment due to excess back pressure, especially when the material is UHPC, which has a relatively high density.

In the embodiments where the generally polyhedral inclusions have an annular structure or central disc, the annular structure or central disc may include a plurality of cut-outs, with the transversely extending structures being in the form of one or more semicircular plates or walls. The transversely extending plates or walls may be parallel, perpendicular, or oriented at any angle therebetween, and may also include cutouts or openings to reduce materials costs and permit venting of steam or passage of cement material past the inclusions. The inclusions may optionally further include outwardly extending pins that improve interlocking of the inclusions when packed together, and/or notches or openings for aligning the inclusions with respect to a mesh or similar reinforcing structure.

In the embodiments where the generally polyhedral inclusions are made up of a plurality of radial extensions from a central hub or intersection of the extensions, and circumferential structures, the circumferential structures may be arranged to form claw or hook like features that are especially advantages in applications involving soil or sand, the claw or hook like features serving as anchors as well as to provide secure interlocking of the inclusions.

Alternatively, the inclusions may include multiple disc structures rather than just a central disc, as well as asymmetric rather than symmetric sets of cutouts, and numerous other variations. In addition, the inclusions may be combined with or replaced by the coiled wire inclusion structures, as well as with reinforcing mesh layers, insulating layers, and other structural features.

The inclusions of the preferred embodiments may be made of polypropylene or a similar relatively inexpensive easily molded plastic material, although the invention is not limited to a particular material and the inclusions may also be made of metal or even concrete. In addition, the sizes of the inclusions can range from nanoscale to several feet, depending on the application.

In the case of multiple loop inclusions, the wires formed into the multiple loops may be made of basalt fibers, and/or the wires may include a core around which the wires are wrapped. If the core is made of plastic, the plastic can be arranged to burn away during a fire, leaving voids into which steam can enter to prevent the concrete from spalling, and the plastic can be partially melted into the surrounding steel or basalt fibers to hold the loop shapes.

The inclusions of the preferred embodiments are especially advantageous when used to reinforce structures such as armor for military applications and earthquake or tornado proof structures. Because the inclusions are inexpensive to manufacture, the add little to the cost of the structures, yet can result in substantially increased structural integrity.

### BRIEF DESCRIPTION OF THE DRAWINGS

FIG. 1A is an isometric view of an inclusion constructed in accordance with the principles of a preferred embodiment of the invention.

FIGS. 1B-1E are respective top, bottom, front side and back side views of the inclusion shown in FIG. 1A.

FIGS. 2A-2E are isometric, top, bottom, front, and back views of a variation of the inclusion of FIGS. 1A-1E.

FIGS. 3A-3E are isometric, top, bottom, front, and back views of a variation of the inclusion of FIGS. 1A-1E.

FIGS. 4A-4C are front, back, and side views of a pinned inclusion according to a preferred embodiment of the invention.

FIG. 5 is an isometric view showing the manner in which inclusions of the type shown in FIGS. 4A-4C interlock.

FIGS. 6A-6D are front, back, isometric, and side views of a variation of the pinned inclusion of FIGS. 4A-4C.

FIGS. 7A-7D are front, back, isometric, and side views of a further variation of the pinned inclusion of FIGS. 4A-4C.

FIG. 8 is an isometric view of a mesh reinforcing structure using inclusions of the type shown in FIGS. 1A-1E to 3A-3E.

FIG. 9 is an isometric view showing a notched variation of the inclusion of FIGS. 1A-1E.

FIGS. 10A and 10B are isometric views showing alternative mesh reinforcing structures utilizing the inclusion of FIG. 9.

FIGS. 11 and 12 are isometric views showing mesh reinforcing structures with positively interlocking reinforcing structures according to another preferred embodiment of the invention.

FIG. 13 is an isometric view of an isotropic three-dimensional inclusion made up of three discs, each having a plurality of cutouts.

FIG. 13A is an isometric view of a variation of the inclusion of FIG. 13, in which two of the discs have cutouts that are open.

FIG. 14 is an isometric view of a further variation of the inclusion of FIGS. 13 and 13A, in which all of the cutouts are open to form a generally spherical isotropic inclusion having claws or hooks.

FIG. 15 is a top view of the inclusion of FIG. 14.

FIG. 16 is an isometric view showing the manner in which inclusions of the type shown in FIGS. 14 and 15 form an interlocking structure.

FIGS. 17 and 18 are isometric views of an injection mold apparatus for forming the inclusion of FIGS. 14-16.

FIGS. 19-22 are isometric views of further variations of the preferred inclusions.

FIG. 23A is an isometric view of a variation of the preferred inclusions that includes two intersection discs.

FIGS. 23B and 23C are isometric views of stamped and formed inclusions according to a preferred embodiment of the invention.

FIGS. 23D-23H are isometric, top, bottom, front, and back views of a variation of the inclusion of FIGS. 1A-1E.

FIG. 231 is an isometric view of a variation of the inclusion of FIGS. 23D-23H.

FIGS. 24A and 24B are respective isometric and cut-away isometric view of a preferred inclusion in the form of a hollow sphere with radially extending pins.

FIG. 25 is a perspective view of a mesh reinforcing structure that uses the inclusion of FIGS. 24A and 24B.

FIGS. 26 and 27A-27C are side views of inclusions made up of wires formed into multiple loops.

FIG. 27D is an isometric view showing a portion of a wire structure for use in the inclusions of FIGS. 26 and 27A-27C.

FIG. 28 is an isometric view of an insulated structure utilizing preferred inclusions.

FIG. 29 is an isometric view of a cylindrical cast concrete structure utilizing the preferred inclusions.

### DETAILED DESCRIPTION OF THE PREFERRED EMBODIMENTS

The present invention involves both an improved method of making ultra high performance concrete (UHPC) structures, and inclusions suitable for use in UHPC structures. Although disclosed in the specific context of UHPC, the method of the invention, which involves vacuum curing, is applicable to concrete structures other than those that utilize UHPC, while the inclusions of the preferred embodiments may be used in application other than those involving UHPC or concrete. In addition, the method of the invention may be applied to concrete structures that utilize inclusions other than those of the invention, while the preferred inclusions may be included in concrete structures formed and cured by conventional forming and curing methods. Initially, an especially preferred embodiment of an inclusion will be described, followed by a description of the concrete structure forming method of the invention, and descriptions of additional preferred inclusions and structures utilizing the preferred inclusions.

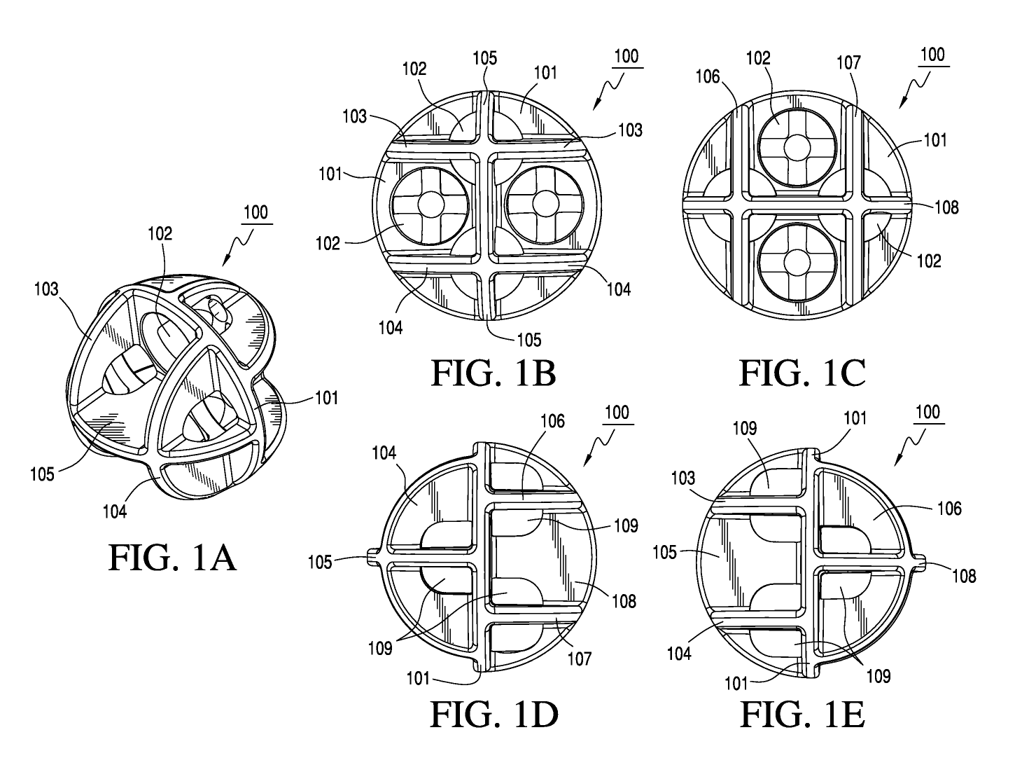

FIGS. 1A-1E show an inclusion 100 constructed in accordance with the principles of a first preferred embodiment of the invention. Inclusion 100 has a generally polyhedral shape defined by a central generally disc-shaped structure 101 having a plurality of cut-outs 102. Central disc 101 provides a parting plane for the two halves of an injection mold, with the structures on each side of disc 101 being formed by injection into the respective halves without the need for additional forming steps, such as the insertion into the mold of pins.

Extending from a first side of the central disc is a pair of parallel semicircular plates or walls 103,104 and a transversely extending semicircular plate or wall 105. Extending from a second side of the central disc 101 is a pair of parallel semicircular plates or walls 106,107 and a transversely extending semicircular plate or wall 108. The pair of walls 103,104 on one side of the central disc 101 are transverse to the pair of walls 106,107 on the opposite side of the central disc 101 and the single transverse wall 105 on the first side is transverse to the single transverse wall 108 on the second side. Because walls 103,104,106,107 extend along chords rather than across an entire diameter of the central disc 100, it will be appreciated that they have a smaller area than the corresponding walls 105,108, with the result that the profile of the inclusion is slightly asymmetric, as can best be seen in FIGS. 1D and 1E. Finally, notches or openings 109 are included in each of the semicircular walls 103-108.

The inclusions of FIGS. 1A-1E, and of the inclusion embodiments described below, may be made of polypropylene or a similar relatively inexpensive, easily molded plastic material, although the invention is not limited to a particular material. Sizes of the inclusions for different applications can range from nanoscale to several feet, with preferred inclusion sizes for UHPC applications ranging from ½ to 2 inches in diameter. Not only are the molded inclusions described herein cheaper than conventional fiber inclusions, but they also take up more space when used in a concrete or UHPC structure, further decreasing cost by reducing the amount of cement or UHPC material required.

In applications involving UHPC or other concrete materials, the inclusions may be added while the concrete is in a concrete mixer, before pouring into the mold. However, it is especially advantageous to pour the balls into the mold first and then pour the concrete into the mold to fill up the voids between the balls and mold walls that seal the mold, after which a vacuum may be applied to the mold to remove air bubbles and rapid cure the concrete. Filling the balls into the mold first allows the balls to compress against each other forming a uniform three-dimensional matrix that strengthens its compression and torsion strengths when the concrete is added last. The weight of the poured or pumped concrete will add a compressive pre-load to the balls to force them to nest tighter against each other during the filling.

The use of a vacuum to cure the UHPC material and remove air from the mold has advantages apart from the advantages of the inclusions described herein, and may be applied to UHPC materials even when conventional inclusions, such as metal fibers, are used. There are a variety of ways of achieving the vacuum. For example, the mold can be provided with a seal and a check valve to maintain the vacuum, or a hermetically or gasket sealed bag with a check valve can be placed over the mold. In addition, use of the vacuum can be combined with conventional steam curing to reduce the amount of steam required, and the vacuum mold can be employed as part of a metal, wooden, fiberglass, or composite tooling. Still further, even if the concrete is cured by conventional steam curing, the use of the preferred inclusions has the advantage that, as the inclusions shrink under the applied heat, additional voids will be formed to accommodate excess steam, allow steam to exhaust pressure, and prevent heat exploding spalling concrete.

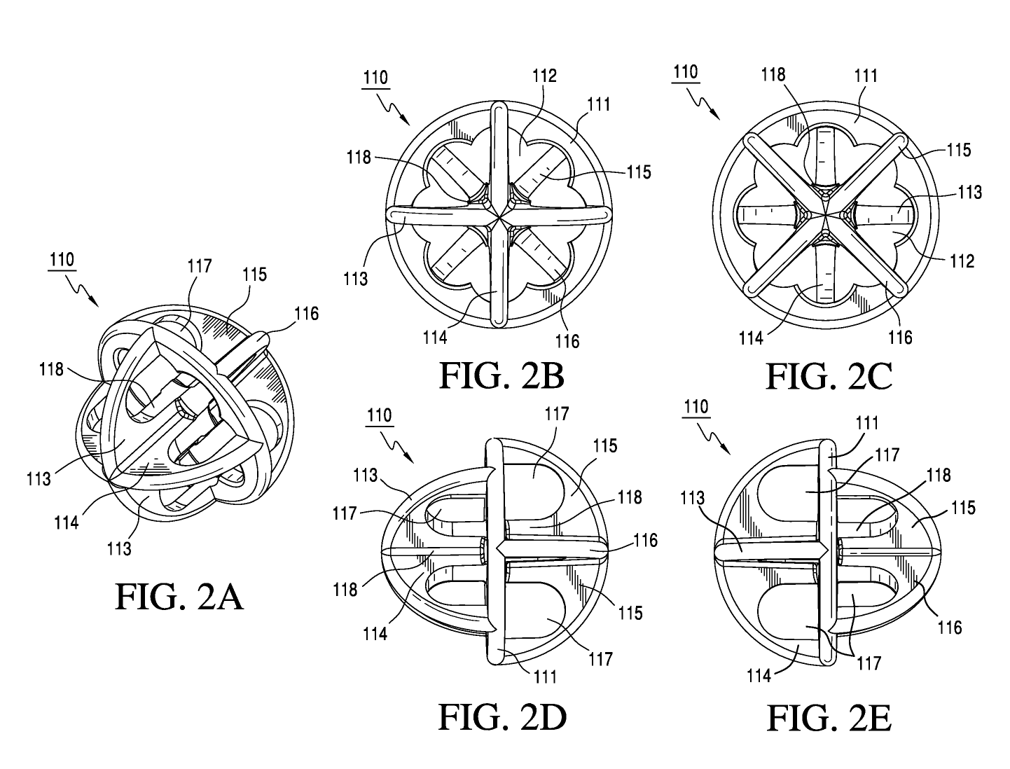

FIGS. 2A-2E show a variation of the inclusion structure of FIGS. 1A-1E. In the inclusion 110 of this embodiment, the central disc 101 and circular cut-outs 102 of the embodiment of FIGS. 2A-2E are replaced by an annular central structure 111 and continuous cutout 112, and respective pairs of semicircular walls 113,114 and 115,116 on opposite sides of the central annular structure 111 are oriented at a mutual angle of 45 degrees and extend diametrically across the annular structure. Each of the semicircular walls 113-116 includes a cutout 117, and the inclusion further includes an axially-extending central structure or pillar 118 extending from all four of the semicircular walls for added strength or rigidity in the plane transverse to the central annular structure 111. Because of the asymmetry of this inclusions structure, the structures will tend to align when concrete or UHPC is poured over the structures in a concrete casting mold. This alignment can be used to provide greater strength in a desired direction, depending on the geometry of the mold and the manner in which the cement material is poured. The materials and molding characteristics of the inclusion 110 of this embodiment, as well as the applications in which the inclusion is used, may otherwise be similar to those of the preferred embodiment of FIGS. 1A-1E.

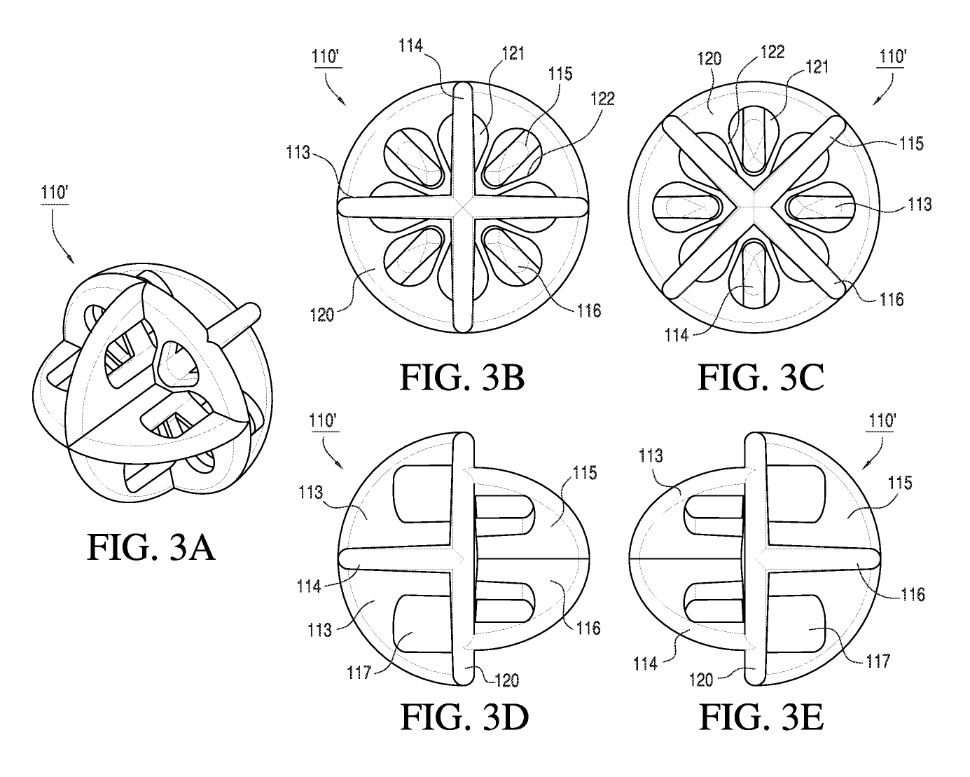

FIGS. 3A-3E show a further variation of the embodiments of FIGS. 1A-1E and 2A-2E, in which the central annular structure 111 and cur out 112 of the embodiment of FIGS. 2A-2E are replaced by a central disc 120 with ovoid cutouts 121 that form spokes 122 to provide added strength or rigidity in the radial direction of the discs. The inclusions 110′ of FIGS. 3A-3E are otherwise identical to inclusions 110 shown in FIGS. 2A-2E. It will be appreciated that the size and shape of the cutouts may be freely varied to achieve a desired strength or rigidity, flow-through characteristics of the inclusions (to allow cement or other materials to pass through the inclusions), and/or to affect properties/characteristics such as the ability to accommodate or vent steam present during curing.

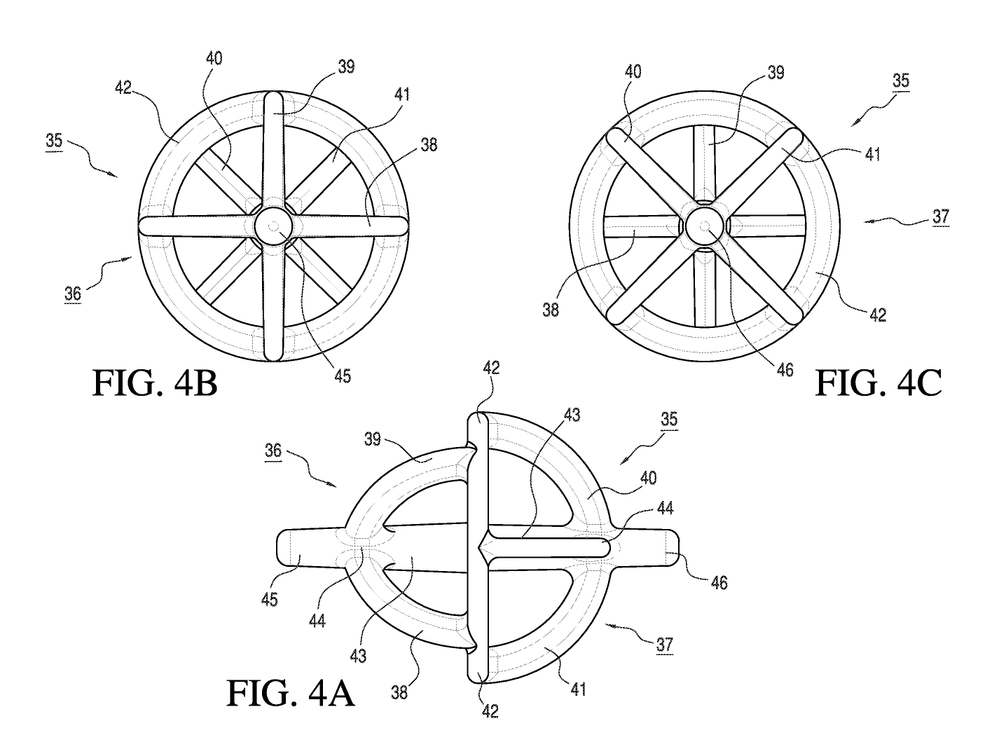

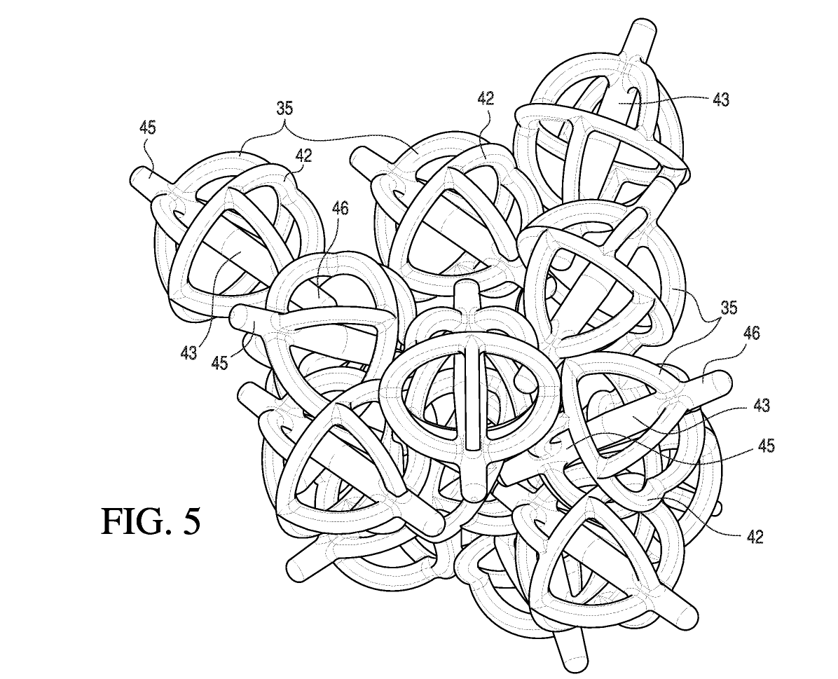

FIGS. 4A-4C variation of the generally-spherical structures of FIGS. 1A-1E, 2A-2E, and 3A-3E, in the form of pinned structures 35 in which the halves 36,37 are formed by pairs of arc-shaped structures 38,39 and 40,41, a central annular structure 42 connecting ends of the arc-shaped structures, and an axial structure 43 extending between the intersections 44 of the arc-shaped structures 38,39 and 40,41 and also beyond the intersections to form pins 45,46 that hook into the rings for improved compression and tensional strength, as shown in FIG. 5.

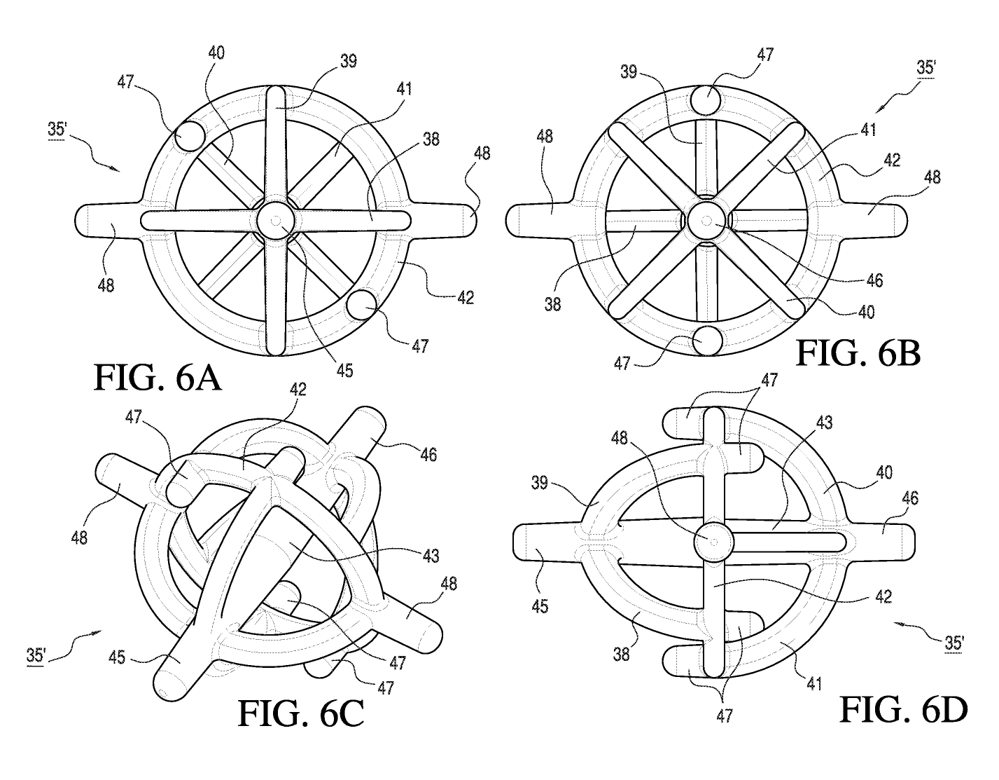

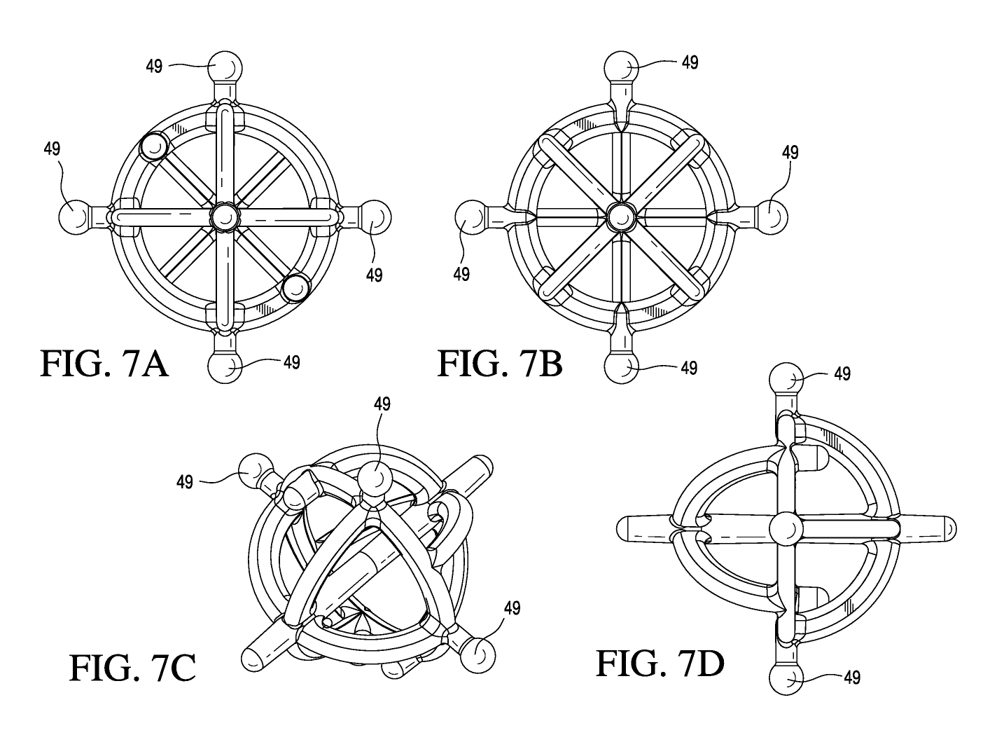

As with the inclusion structures of FIGS. 1A-1E to 3A-3E, an advantage of the inclusion structure of FIGS. 4A-4C is that moving pins are not required during injection molding, simplifying the injection molding process and reducing costs. Furthermore, additional pins 47,48 can easily be formed at ends and/or intersections of the arc-shaped structures 38,39 and 40,41 to obtain modified inclusions 35′, as shown in FIGS. 6A-6D. Still further, spherical members 49 may be added to one or more of the pins 45-48 included in the inclusion structure 36′ of FIGS. 6A-6D, as shown in FIGS. 7A-7D, to provide improved gripping or hooking effects. The pinned inclusions of FIGS. 4A-4D, 6A-6D, and 7A-7D are especially useful in armored or explosion-proof panels, in which the pins provided an added anchoring effect to prevent the inclusions from being ejected from the concrete when subjected to an explosive force.

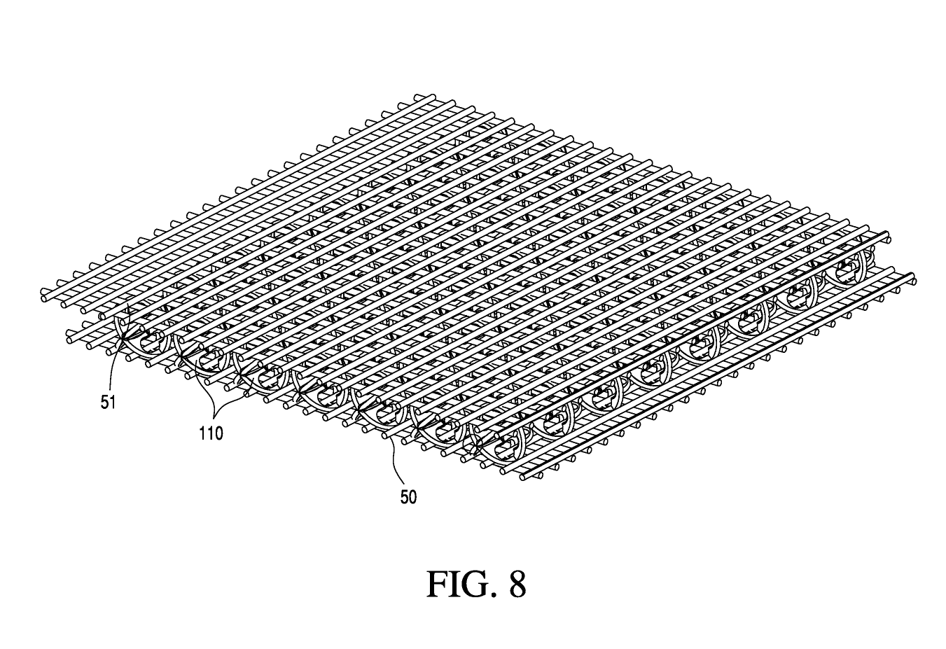

FIG. 8 shows an application of the inclusions of FIGS. 1A-1E, 2A-2E, and 3A-3E, in which inclusions are placed between steel, plastic or fiberglass concrete-reinforcing mesh layers 50 and 51, the inclusions acting both as a spacer for the mesh as well an anchor. Although the specific inclusions depicted correspond to inclusions 110 of FIGS. 2A-2E, it will be appreciated that mesh layers may be used with any of the inclusions described herein.

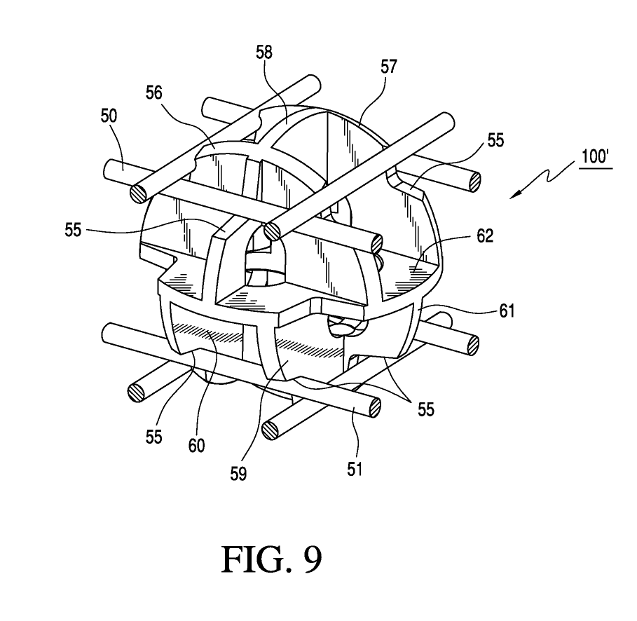

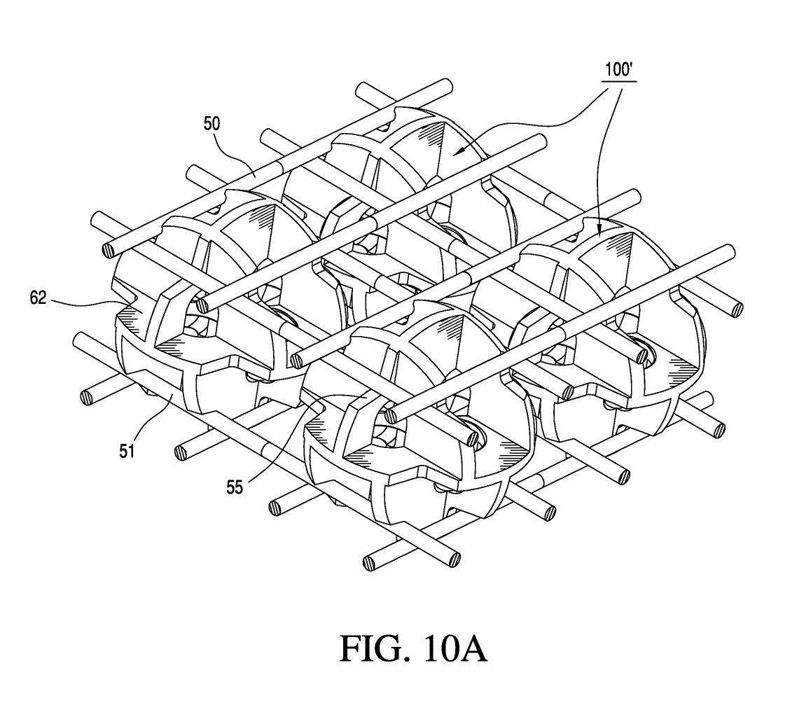

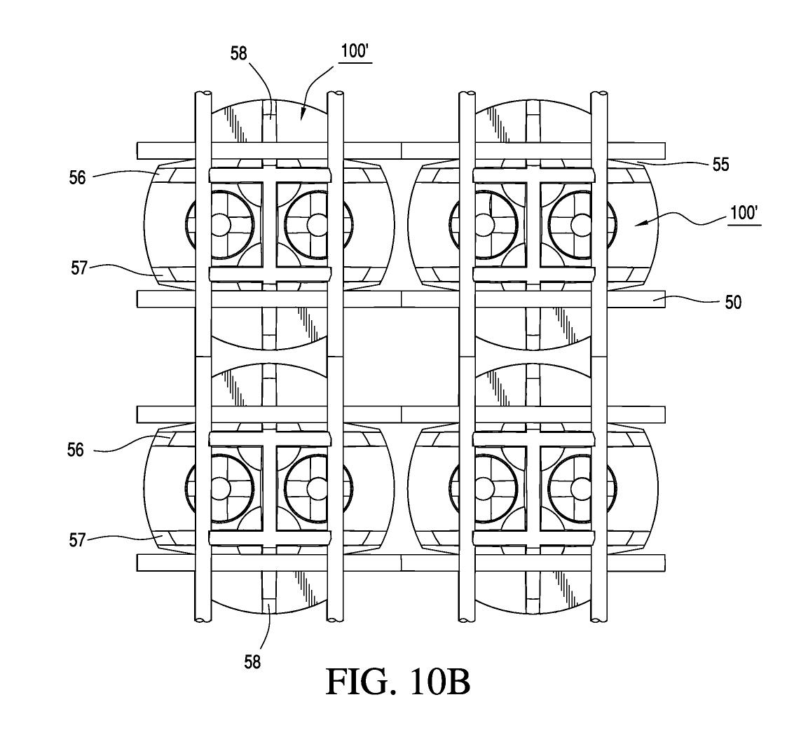

FIGS. 9, 10A, and 10B show an inclusion 100′ that corresponds to inclusion 100 of FIGS. 1A-1E, except that it further includes cut-outs 55 in the semi-circular walls 56-61 extending from central disc 62, semi-circular walls 56-61 being otherwise identical to semi-circular walls 103-108 of FIGS. 1A-1E. Cut-outs 55 serve to align the inclusions 100′ with the mesh layers 50,51 to provide additional strength. As shown in FIG. 10A, the inclusions may be aligned in parallel or, as shown in FIG. 10B, the inclusions may be oriented such that corresponding walls 56-58 of adjacent inclusions 100′ are at 90° angles. Alignment may be achieved by hand or by a robot.

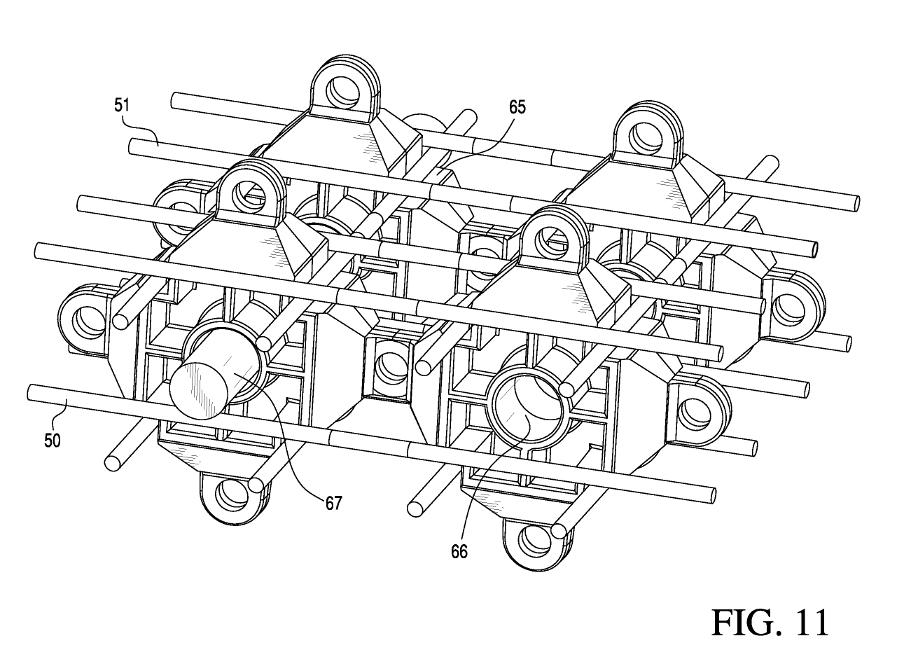

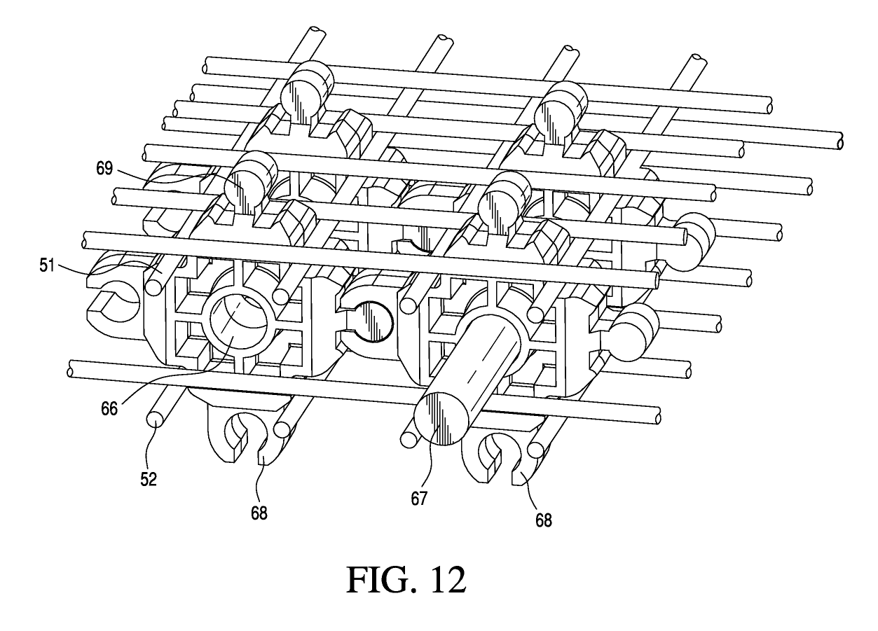

Still further strength, suitable for heavy load and earthquake proofing applications, may be achieved by providing the inclusions with both cut-outs 66 for the wire mesh layers 50,51 and openings 67 for additional strengthening rebarb pins 68, as shown in FIG. 11, and/or by providing optional interlocking parts such as the tongue and groove structures 68,69 illustrated in FIG. 12.

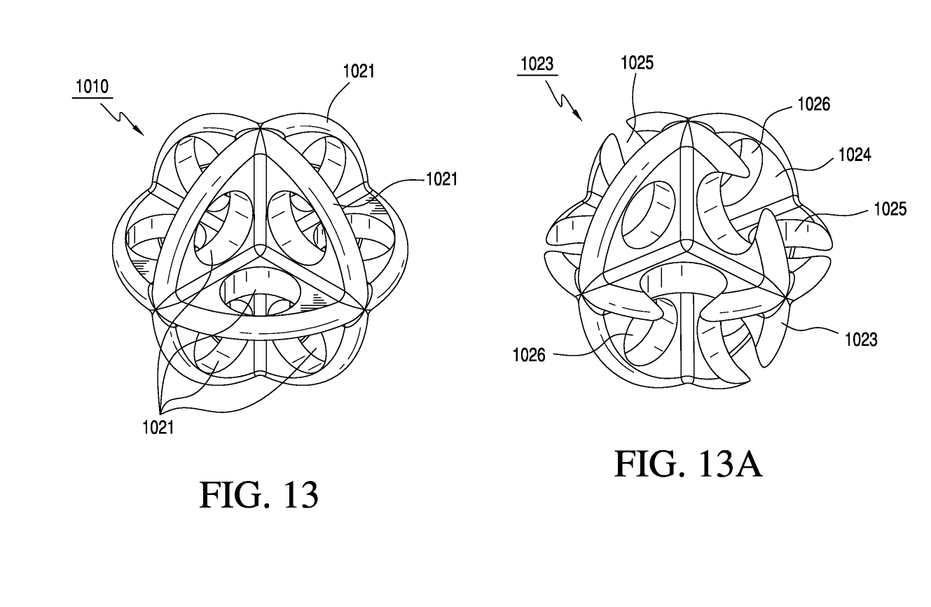

FIG. 13 shows a modification of the inclusions of the preferred embodiments illustrated in FIGS. 1A-1E, 2A-2E, and 3A-3E, in which the inclusion 1010 is defined by two transverse central discs 1020,1021, each having circular cut-outs 1022. It will be appreciated by those skilled in the art that the number and configuration of the cut-outs in each of the discs 1020,1021 may be freely varied, although the inclusions of this embodiment do require additional molding or manufacturing steps, such as the insertion of pins into the mold, to form the cut-outs in at least one of the central discs.

The inclusion of FIG. 13 can be modified by having the cut-outs 1022 in at least one of the discs extend to the perimeters of the discs to create an inclusion 1010′ with respective discs 1023 and 1024 having both open cut-outs 1025 and closed cut-outs 1026, as illustrated in FIG. 13A. In addition, or instead of the modified cut-outs, the central discs 1024,1025 may have different diameters. An advantage of the asymmetric inclusion 1010′ of this embodiment is that the degree of alignment of the inclusions with the direction of flowing cement material can be controlled based on the differences in size between the central discs and respective cut-outs.

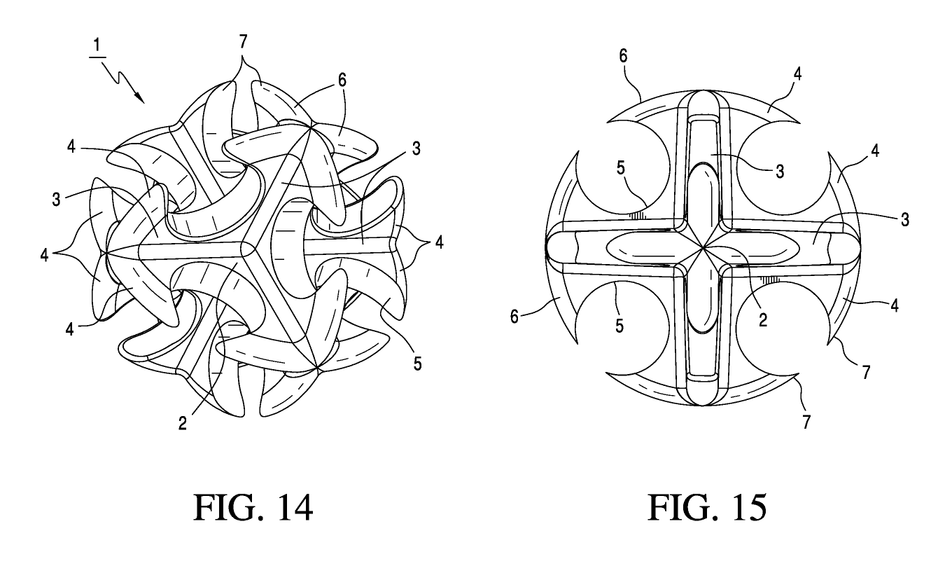

The inclusion 1010′ of FIG. 13A can be further modified to provide each of the central disc structures with open cut-outs, as illustrated in FIGS. 14 and 15, to obtain a generally polyhedral inclusion 1 with claw or hook like features including a central core or hub structure 2 and a plurality of radially-extending projections 3 having circumferential extensions 4 that provide an anchoring effect.

Inclusions with claw-like structures such as inclusion 1, and to a degree inclusion 1023 of FIG. 13A, are not only useful as concrete reinforcement inclusions, but also are especially useful for soil and shoreline erosion prevention because the claw-like structures dig into the soil to provide an anchoring effect. Molding of the embodiment of FIGS. 14-15 is somewhat more difficult than for the embodiments of FIGS. 1A=1E to 3A-3E since movable pins are necessary to create the cut-outs, but the inclusion provides has advantages with respect to anchoring and the isometric nature of the inclusions.

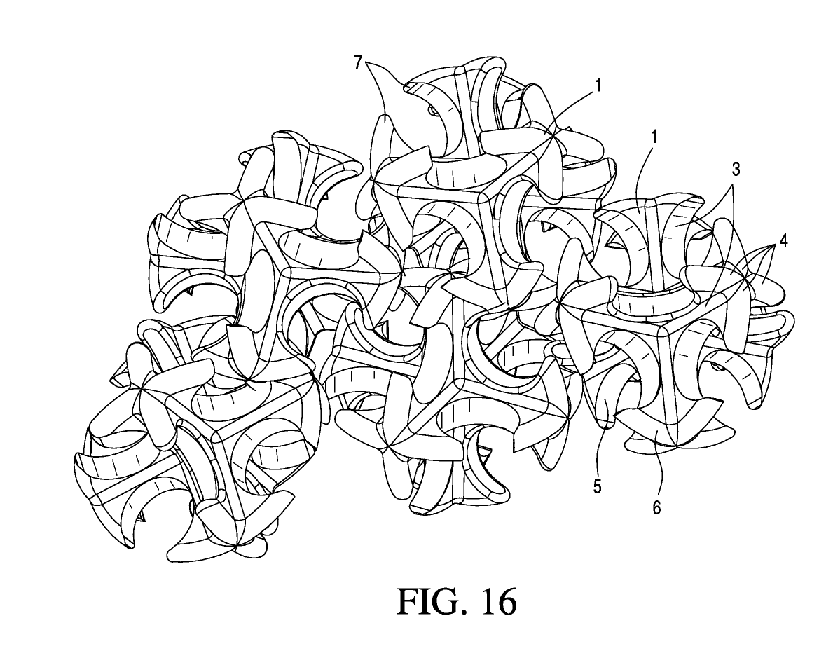

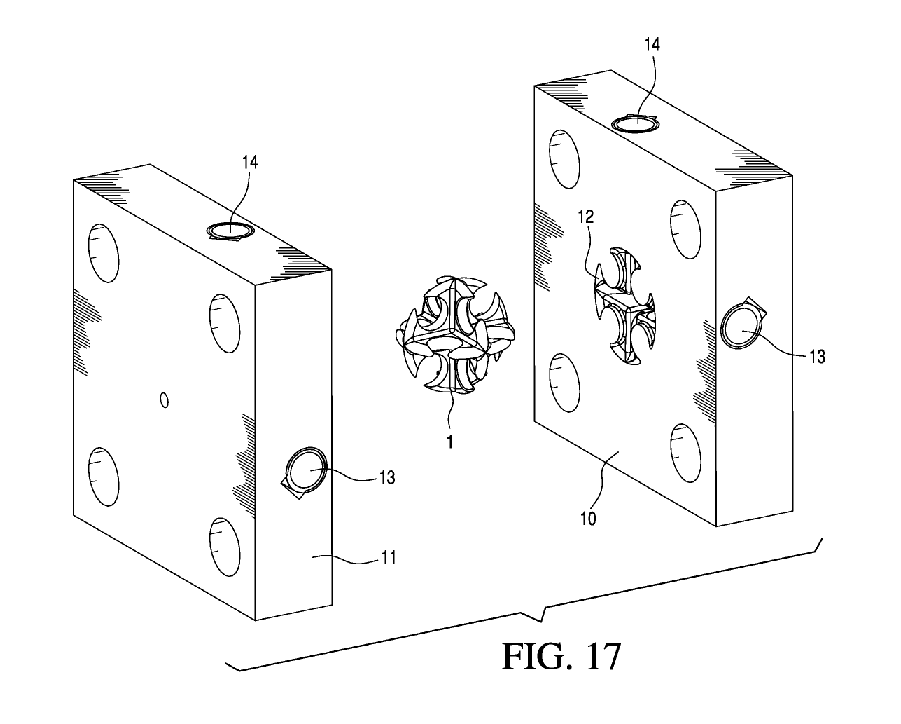

In the inclusion 1 of FIGS. 14 and 15, the radially-extending projections each include four of the circumferential extensions 4, extending transversely from the projections at 90 degree angles. When viewed in cross-section, the projections have arc-shaped concave sides 5, while the circumferential extensions have arc-shaped convex structures outer surfaces 6 that end in points 7. As a result of this structure, as shown in FIG. 16, individual inclusions 1 can hook into each other to form an even stronger reinforcing structure.

As with the inclusions of FIGS. 1A-1E to 3A-3E, the inclusions of FIGS. 13-15 may be made of polypropylene or a similar relatively inexpensive easily molded plastic material, although the invention is not limited to a particular material. Sizes of the inclusions for different applications can again range from nanoscale to several feet, preferred ball sizes for UHPC applications are ½ to 2 inches in diameter. The inclusions of this embodiment may also be used with the novel UHPC molding and curing process described above, in which the inclusions are first poured into the mold and then the cement material is poured into the mold, without or without initially placing the balls under tension, to fill up the voids between the balls and mold walls that seal the mold, after which a vacuum may be applied to the mold to remove air bubbles and rapid cure the concrete.

When used in soil retention applications, the inclusions of FIGS. 14-16 can be placed in run off drainage ditches and fields to anchor the soil and prevent erosion, and can be buried so that plant roots can anchor themselves to the inclusions underground so as to survive high winds and rains, and reduce mud slides. The inclusions of FIGS. 14-15 are cheaper to transport than heavy rocks and easier to spread around with a superior anchoring ability, while permitting water to easily pass through. When the inclusions are sitting on the ground, eight of the points 7 are contact points that dig into the ground. In addition to soil retention, the inclusions may be used as reef balls or sea wall structures, and may be stacked on top of one another to force the bottom inclusions to dig into the ground, the inclusions interlocking to form an exceptionally stable sea wall or reef structure. In such applications, the balls are preferably several feet in diameter, and may be made of a materials such as concrete.

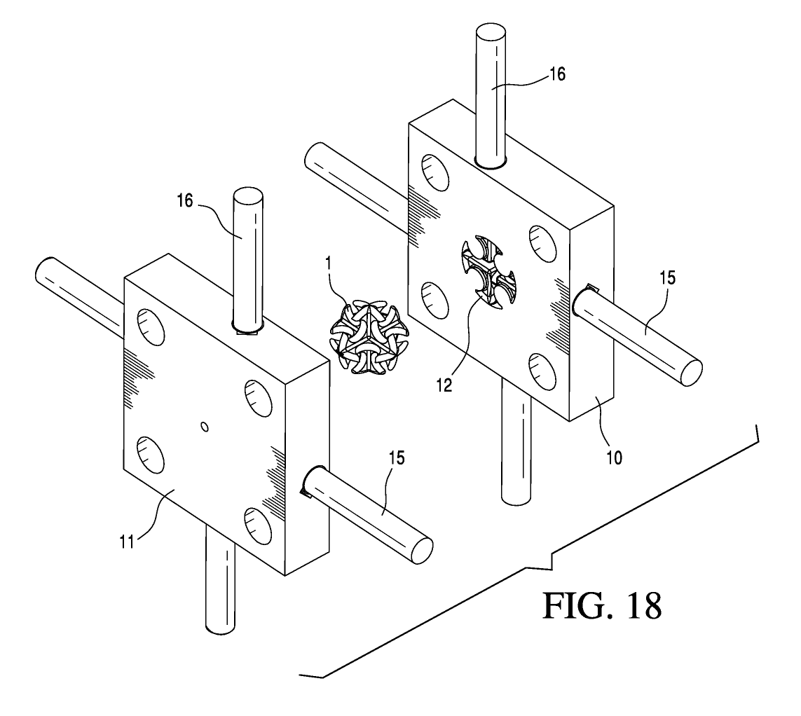

FIG. 17 shows a two-piece molding apparatus 10,11 including openings 12 in each half for forming an inclusion such as inclusion 1 of FIGS. 14 and 15. Openings 13 and 14 in each half 10,11 accommodate sliding pins driven by hydraulic cylinders 15,16 to form cut-outs in planes transverse to the parting plane of the mold, as shown in FIG. 18.

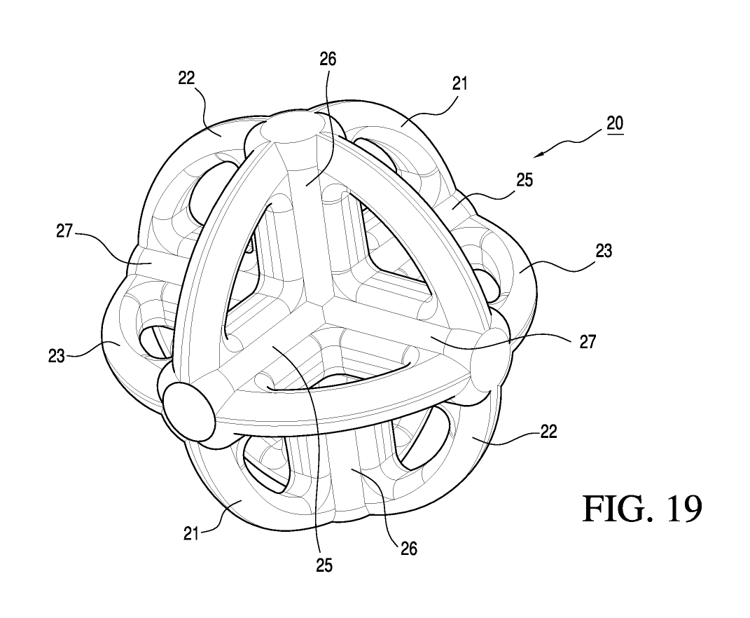

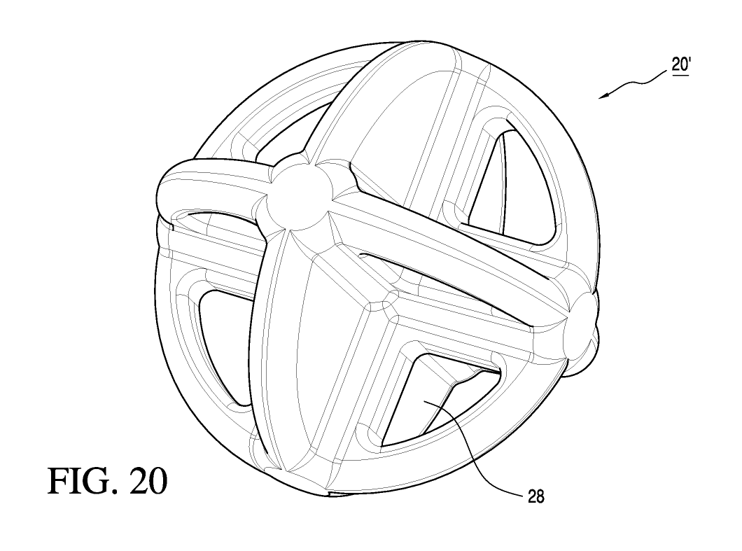

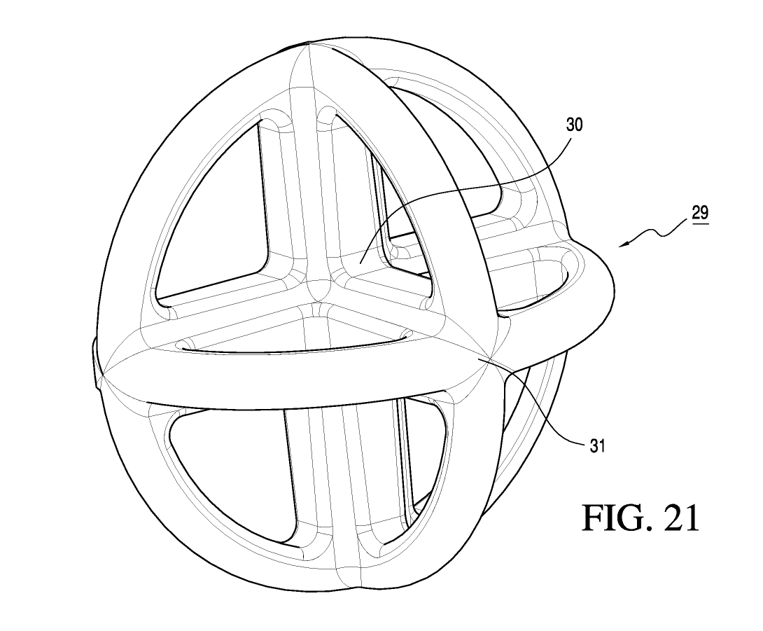

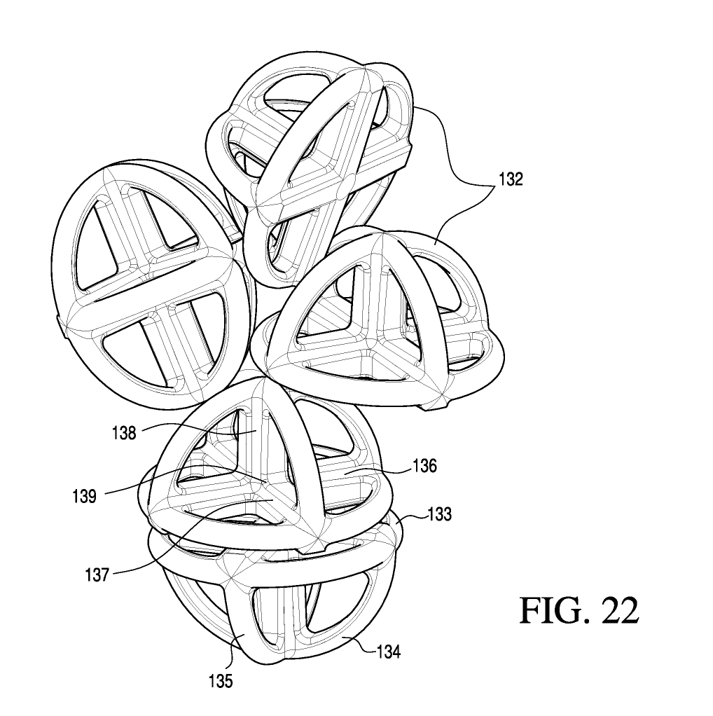

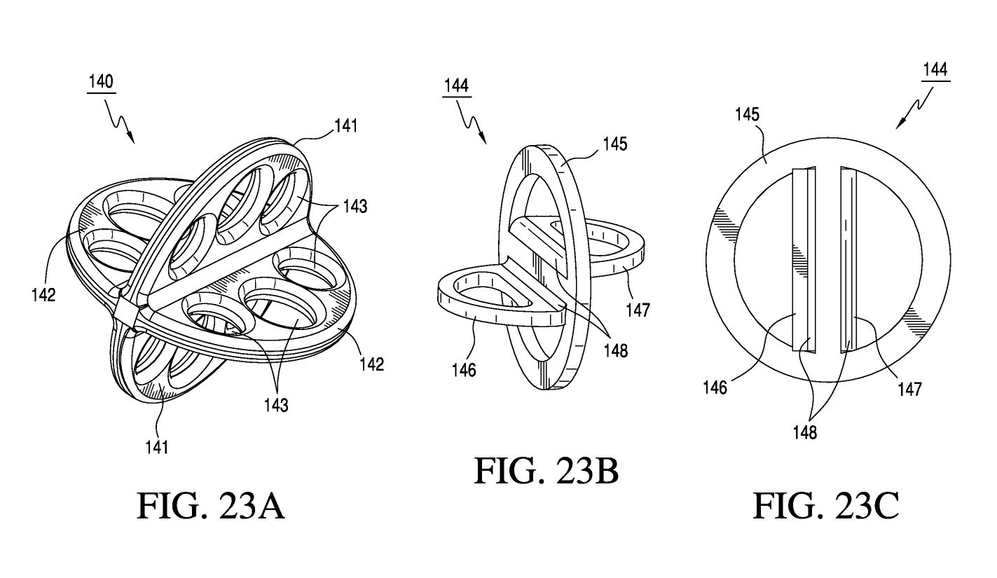

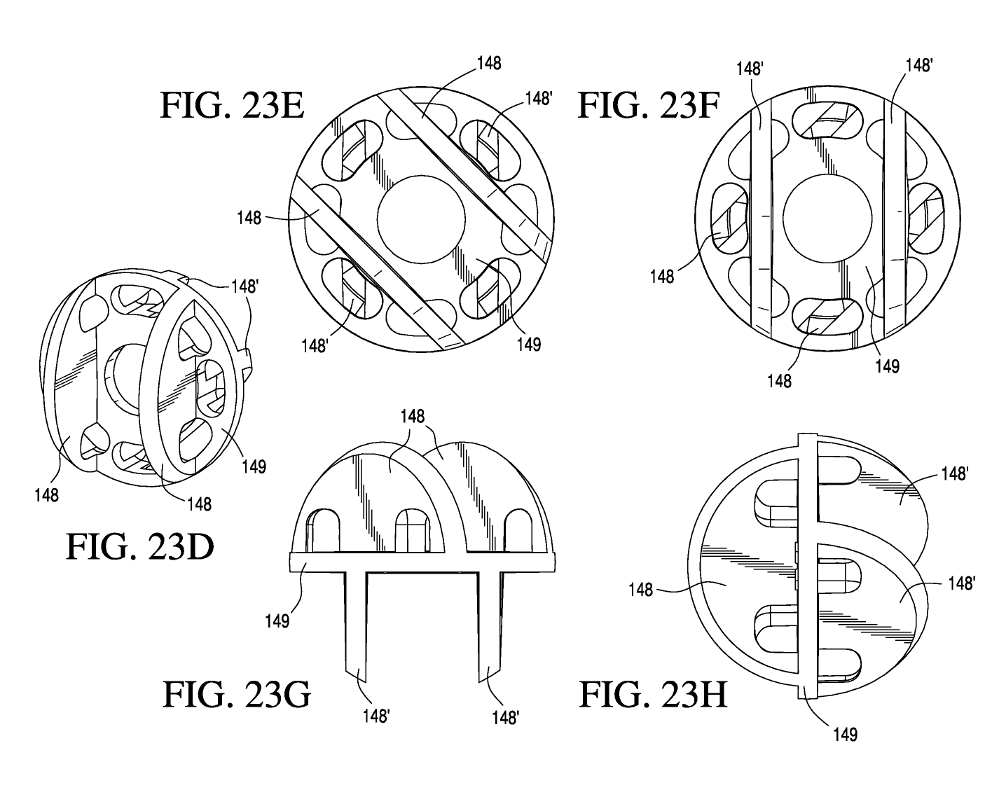

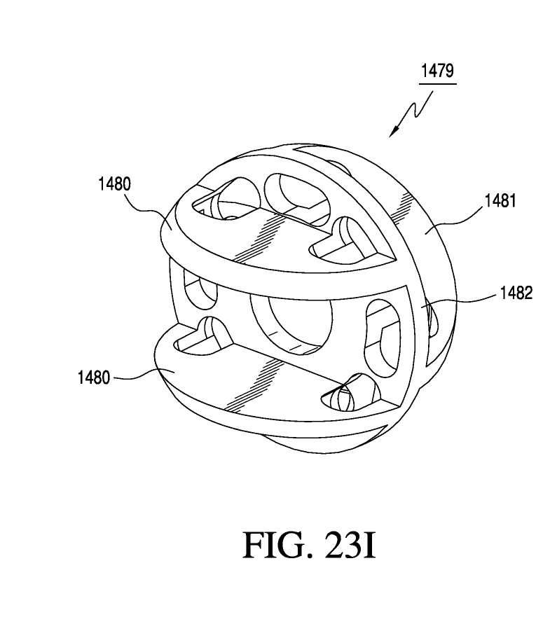

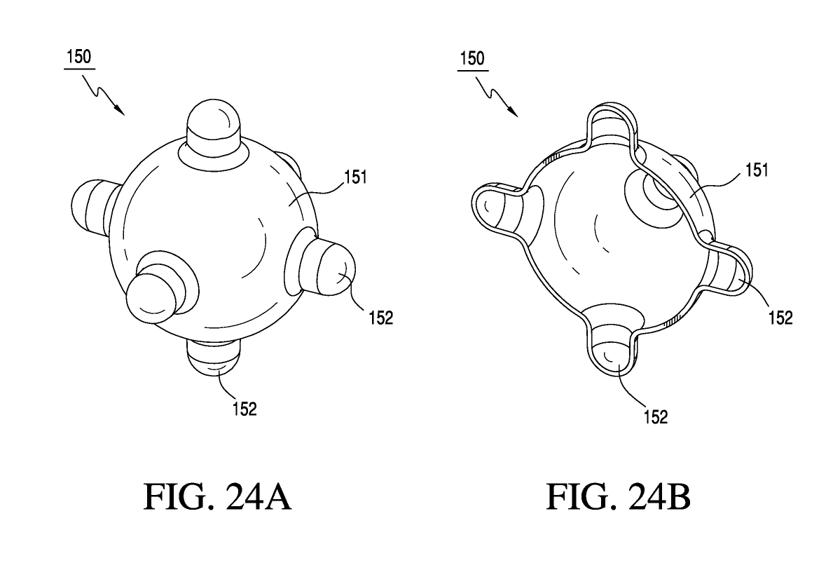

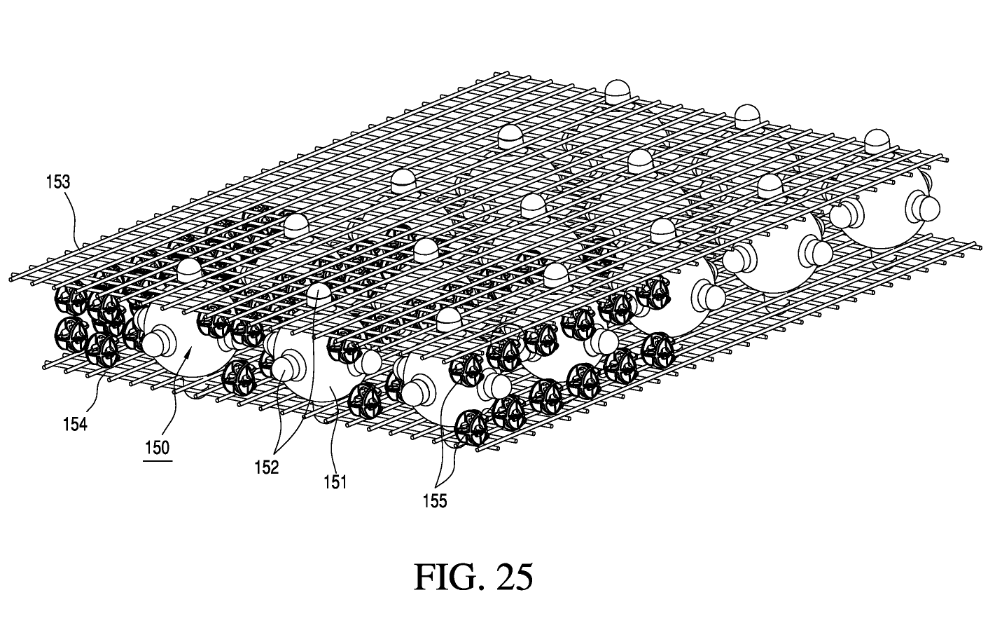

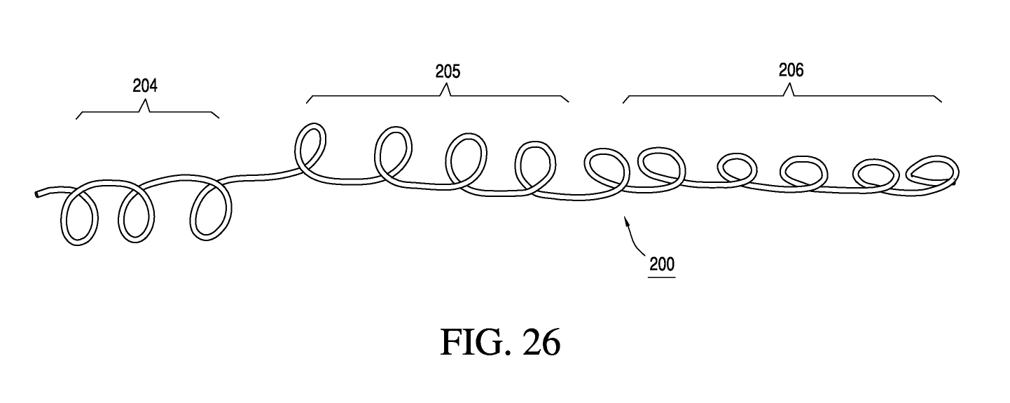

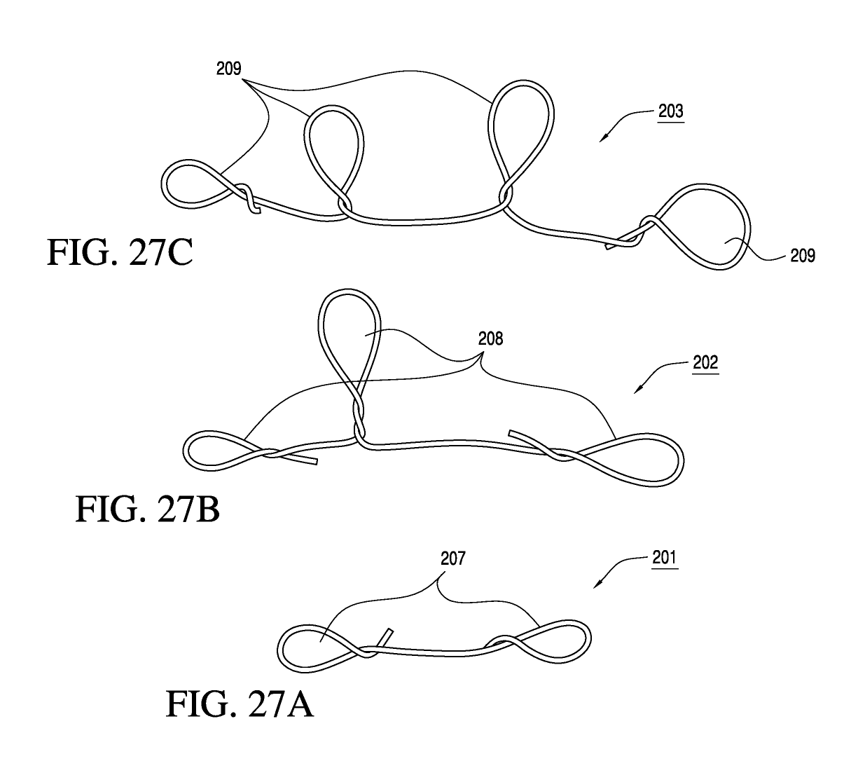

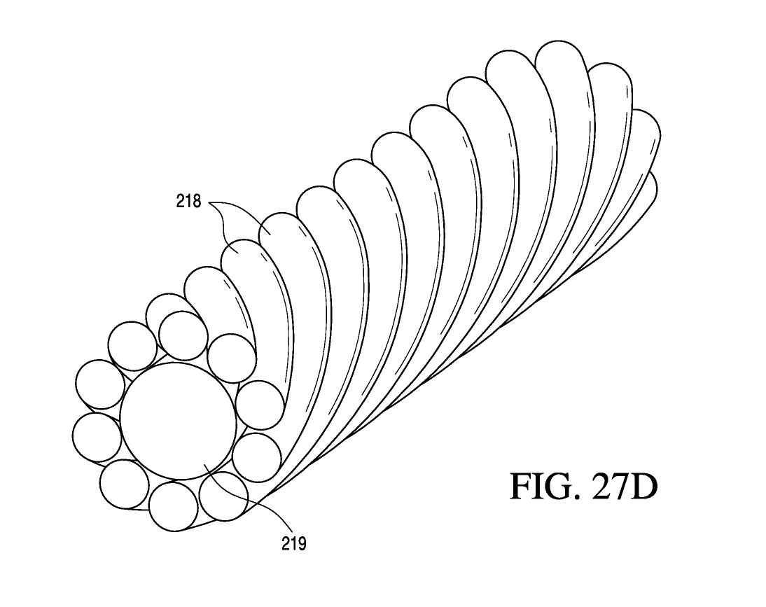

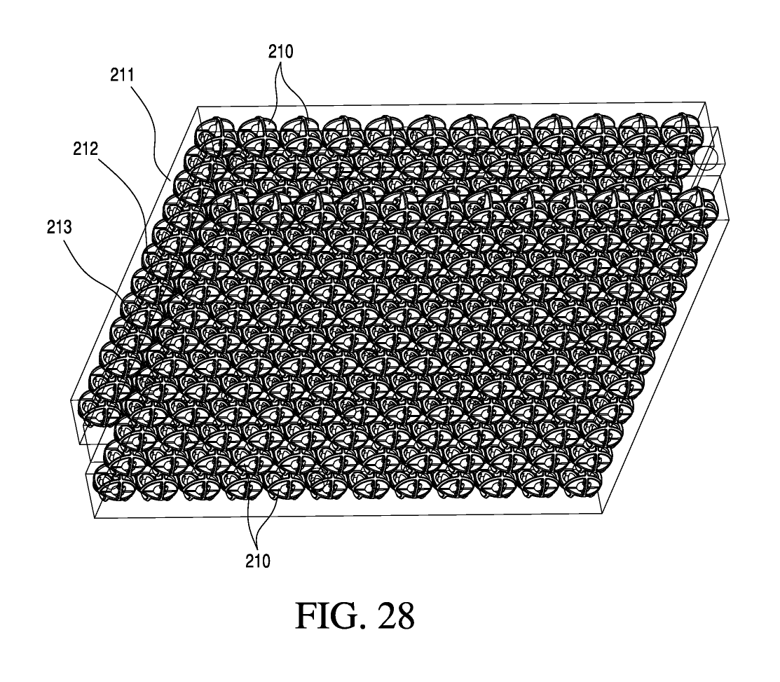

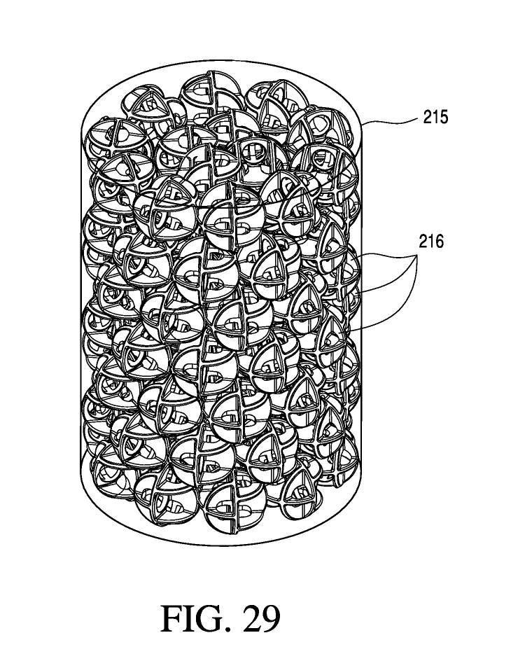

While the inclusion structures described above are especially preferred, numerous variations of the above structures are possible. For example, FIG. 19 shows a variation of the inclusion of FIG. 13, in the form of a generally-spherical isotropic structure 20 made up of three transversely extending annular structures 21-23 corresponding to the equator and four meridians of a sphere. The intersections 24 of the annular structures are connected by three sets of axially extending structures 25-27. FIG. 20 shows an inclusion structure 20′ that is identical to that of FIG. 19, except that one of the annular structures is modified to form a solid disc structure 28, in order to provide a degree of anisotropy and/or cause the inclusion structure to self-align during pouring of a cement material. FIG. 21 shows a further variation with slightly modified hub structures 30 and annular structures 31. FIG. 22 shows multiple inclusions 132 similar to those of FIG. 21, but that are hemispherical in shape, the shape of the inclusion being defined by an annulus 133 and two perpendicularly extending semi-circular structures 134 and 135, connected by pillars 136-138 to a hub 139. FIG. 23A shows an inclusion 40 formed by two intersecting discs 141,142 with cut-outs 143 in each disc, while FIG. 23B shows an inclusion 144 made up of a disc 145, preferably made of metal, and two perpendicular sections 146 and 147 which may be formed by cutting or stamping semi-circles into the disc and bending the sections along the base 147′ of the stamped semi-circles. FIG. 23C shows a variation 144′ of the stamped inclusion of FIG. 23B, in which holes 145′ are added to disc 145 to provide an enhanced anchoring effect. Finally, FIGS. 23D-23H show an arrangement in which the respective semi-circular walls 148 that extend from opposite sides of a disc 149 are at a nonzero angle, and FIG. 23I shows a modification of the arrangement of FIGS. 23D-23E in which the respective semi-circular walls 1480 and 1481 extending from central disc 1482 of an inclusion 1479 differ in number, with two walls 1480 on one side and a single wall 1481 extending from the other side at a nonzero angle with respect to walls 1480.

Yet another alternative inclusion structure is illustrated in FIGS. 24A and 24B, and FIG. 25, which show spherical pinned inclusion structures 150 in the form of hollow spherical core structures 151 and projecting pins 152. The projecting pins 152 may extend from the core structure along three perpendicular axes, so that the number of projecting pins 6, the number and/or angles of the projecting pins may be varied to achieve anisotropic effects, if desired. The projecting pints align the inclusions 150 with mesh layers 153,154, as shown in FIG. 25. Additional inclusions 155 may also be provided, as shown in FIG. 25, to provide additional strength and reduce the amount of cement required. The additional inclusions may correspond, by way of example and not limitation, to the inclusions illustrated in FIG. 1A-1E, 2A-2E, or 3A-3E.

In addition to the above-described three-dimensional inclusions, it is possible to include other types of inclusions in a UHPC or other concrete material. FIGS. 26 and 27A-27C show novel inclusions 200-203 made of wire formed into multiple loops. These inclusions may be used in connection with, or instead of, the three-dimensional inclusions of the above-described embodiments, and are not limited to use in UHPC or vacuum-cured concrete materials.

In the inclusion of FIG. 26, three sets of loops 204-206 are formed, each set being oriented at a different angle when viewed from an end of the inclusion. Because the sets of loops 204-206 are oriented at different angles, the resulting inclusion 200 has a three-dimensional structure to provide added strength in multiple directions. This arrangement also has the advantage that when the inclusion is subject to a tensile force, the loops will tighten around concrete material within the loops to prevent the inclusion from being pulled or ejected from the concrete structure. The tightening effect makes the inclusion 200 especially suitable for use in armored structures or structures subject to explosive forces or impacts. Similar effects are provided by the loops 207-209 of the inclusions of FIGS. 27A-27C, any or all of which may replace or be used in addition to the inclusion of FIG. 26.

The wire inclusions 200-203 of FIGS. 26 and 27A-27C may be made of solid wires. However, additional advantages are obtained if the inclusions are made of tubes. In that case, the tubes serve to vent excess steam that can result when the concrete material is subject to heat, thereby relieving pressure that would otherwise result in cracking or explosion of the concrete material in which the inclusions are situated. In addition, as shown in FIG. 27D, the wires may be made of wires 218 twisted around a center reinforcement core 219.

In additional to conventional metal wires, for example made from low carbon or stainless steel, the inclusions 200-203 of FIGS. 26 and 27A-27C may advantageously be made of basalt fibers. The basalt fibers may, in the configuration illustrated in FIG. 27D, be wrapped around a stainless steel reinforcement core to eliminate corrosion, with the stainless steel reinforcement holding the shapes of the inclusions and the basalt fibers providing strength. On the other hand, the same shape may be achieved by wrapping plastic fibers around a central core of steel or basalt fibers, or by wrapping steel or basalt fibers around a plastic center core. In the case of a plastic core 219 surrounded by basalt fibers 218, the plastic could be arranged to burn away in a fire, leaving a void for steam to enter and prevent the concrete from spalling. Still further, if the plastic core is heated during formation of the loop shapes, the plastic can be caused to melt into the outside basalt or steel fibers to hold the loop shape. Finally, the wire of FIG. 27D may also be modified to be in the form of a braided tube with a center core that will dissolve in alkaline concrete leaving a void for steam, the braided material being selected from tempered or stainless steel, basalt fibers, plastic, and ceramic. The plastic core can be heated to hold its shape using ultrasonic or induction heating, a fluid bath, microwaves, and so forth. Although especially suitable for use in concrete, however, those skilled in the art will appreciate that the looped inclusions of FIGS. 26 and 27A-27D may be used in numerous materials other than concrete, including by way of example and not limitation, asphalt, cement, fiberglass epoxy, resins, and plastic materials.

FIG. 28 shows an application of the UHPC or other concrete material of the present invention, in which inclusions 210 of the type illustrated in FIGS. 1A-1E to 3A-3E, or similar generally spherical interlocking inclusions, are cast into parallel UHPC or other inclusion-containing layers 211 and 212 that sandwich an insulating or other structural layer 213.

The example where layers 211 and 212 are UHPC layers and layer 213 is an insulating layer is especially useful for earthquake or tornado proof structures. Because of the greatly increased strength of the inclusion-containing UHPC or concrete layers, and the relatively low cost of the inclusions, the resulting structure can provide insulated, earthquake or tornado resistant housing structures that cost little more than conventional concrete housing structures. While such structures would be subject to cracking during an earthquake or tornado, the interlocking inclusions would prevent the structure from complete failure or collapse, and thus prevent the massive loss of like that occurred during, for example, the Haiti earthquake of 2010. As an alternative to the sandwiched-insulation layer structure of FIG. 28, it is also possible to fill the inclusions with insulating material such as insulating foam (not shown).

On the other hand, the structure shown in FIG. 28 may also have military applications. A concrete structure with three-dimensional inclusions may be used to absorb explosions and enemy radar on a boat, submarine, or dock. The illustrated structure could be the structure of the boat or an external concrete coating on steel. The layers 211 and 212 shown in FIG. 28 could also be in the form of an epoxy coating with micro-3D inclusions 211 added to the resin. In addition, steel fibers may be added to either the concrete material or the resin material with three-dimensional inclusions to provide additional reinforcement.

An alternative structure that utilizes the inclusions of the invention is shown in FIG. 29. This alternative structure is in the form of a cast-in-place concrete cylinder 215 that contains inclusions 216 of the type illustrated in FIGS. 1A-1E to 3A-3E, or similar generally spherical interlocking inclusions. Such a concrete cylinder may be used in a variety of applications, such as to replace wooden telephone poles or building columns, or as supporting poles for wind turbines. The cylinder has strength in all directions and is advantageous cured using vacuum curing, as described above, to remove the air trapped in the inclusions.

Having thus described preferred embodiments of the invention in sufficient detail to enable those skilled in the art to make and use the invention, it will nevertheless be appreciated that numerous variations and modifications of the illustrated embodiment may be made without departing from the spirit of the invention. Accordingly, it is intended that the invention not be limited by the above description or accompanying drawings, but that it be defined solely in accordance with the appended claims.

I claim:

1. An interlocking, three-dimensional, generally polyhedral reinforcement inclusion for UHPC and other applications, comprising:
at least one central disc-shaped or annular structure that forms a parting plane for an two-piece injection mold, and structures extending generally transversely from opposite sides of the central disc-shaped or annular structure to define a generally polyhedral shape,
wherein said interlocking reinforcement inclusion includes spaces defined by said central structure and said generally transversely extending structures into which corresponding structures of other said reinforcement inclusions extend when placed in a together in a confined space, and through which a casting material can pass.

2. The interlocking, generally polyhedral reinforcement inclusion of claim 1, wherein a material of said structure is polypropylene.

3. The interlocking, generally polyhedral reinforcement inclusion of claim 1, wherein a material of said structure is compressible, such that when said inclusion is surrounded by cement and said cement has set, said structure exerts a restoring force on said surrounding material.

4. The interlocking, generally polyhedral reinforcement inclusion of claim 1, wherein said central disc-shaped or annular structure is a disc and said generally transversely extending structures include at least one semi-circular wall or disc extending from each side of said disc.

5. The interlocking, generally polyhedral reinforcement inclusion of claim 4, wherein two semi-circular walls extend from at least one side of said disc.

6. The interlocking, generally polyhedral reinforcement inclusion of claim 5, wherein two semi-circular walls or plates extend from each side of said disc.

7. The interlocking, generally polyhedral reinforcement inclusion of claim 6, wherein two parallel semi-circular walls and a third semi-circular wall that is perpendicular to the two parallel semi-circular walls extend from each side of said disc.

8. The interlocking, generally polyhedral reinforcement inclusion of claim 7, wherein said two parallel walls on each side of said disc are perpendicular to each other.

9. The interlocking, generally polyhedral reinforcement inclusion of claim 7, further comprising openings in said disc and at least one cut-out in each of said semi-circular walls.

10. The interlocking, generally polyhedral reinforcement inclusion of claim 4, wherein two intersecting semi-circular walls extend from each side of said disc.

11. The interlocking, generally polyhedral reinforcement inclusion of claim 10, wherein said intersecting semi-circular walls are mutually perpendicular and extend diametrically across said disc.

12. The interlocking, generally polyhedral reinforcement inclusion of claim 10, wherein said intersecting walls on one side of said disc are at a non-perpendicular angle with respect to said intersecting walls on the opposite side of said disc.

13. The interlocking, generally polyhedral reinforcement inclusion of claim 4, wherein said semi-circular walls on one side of said disc are parallel and said semi-circular walls on the opposite of said disc are parallel and at a non-zero angle with respect to said semi-circular walls on said one side of said disc.

14. The interlocking, generally polyhedral reinforcement inclusion of claim 4, further comprising openings in said disc.

15. The interlocking, generally polyhedral reinforcement inclusion of claim 15, wherein said openings are teardrop shaped and form spokes in said disc.

16. The interlocking, generally polyhedral reinforcement inclusion of claim 4, wherein said disc includes a single central cut-out.

17. The interlocking, generally polyhedral reinforcement inclusion of claim 4, further comprising cut-outs in said semi-circular walls.

18. The interlocking, generally polyhedral reinforcement inclusion of claim 1, wherein said semi-circular walls have different areas.

19. The interlocking, generally polyhedral reinforcement inclusion of claim 1, wherein said central disc or annular structure is an annular structure.

20. The interlocking, generally polyhedral reinforcement inclusion of claim 19, wherein said transversely extending structures include arc-shaped structures on side of said annular structure.

21. The interlocking, generally polyhedral reinforcement inclusion of claim 19, wherein said transversely extending structures are pairs of intersecting arc-shaped structures.

22. The interlocking, generally polyhedral reinforcement inclusion of claim 21, wherein said intersection arc-shaped structures are mutually perpendicular.

23. The interlocking, generally polyhedral reinforcement inclusion of claim 22, wherein said intersecting arc-shaped structures on one side of said central annular structure are oriented at a nonzero angle with respect to intersecting arc-shaped structures on an opposite side of said central annular structure.

24. The interlocking, generally polyhedral reinforcement inclusion of claim 22, further comprising an axial structure extending between intersections of the arc-shaped structures.

25. The interlocking, generally polyhedral reinforcement inclusion of claim 24, wherein said axial structure extends beyond said intersections of the arc-shaped structures to form outwardly extending pins.

26. The interlocking, generally polyhedral reinforcement inclusion of claim 25, further comprising a pin axially extending from an intersection of said central annular structure and at least one of said arc-shaped structures.

27. The interlocking, generally polyhedral reinforcement inclusion of claim 25, further comprising a pin extending radially from an intersection of said central annular structure and at least one of said arc-shaped structures.

28. The interlocking, generally polyhedral reinforcement inclusion of claim 24, further comprising pins extending from said central annular structure, said pins having knobs at ends of said pins.

29. The interlocking, generally polyhedral reinforcement inclusion of claim 1, wherein said central disc or annular structure is a disc, and said transversely extending structures include at least a pair of parallel semi-circular walls on one side of said disc and a pair of parallel semi-circular walls on an opposite side of said disc, said semi-circular walls including notches for receiving wires of wire mesh sheets placed on opposite sides of a plurality of said inclusions.

30. The interlocking, generally polyhedral reinforcement inclusion of claim 29, wherein said semi-circular walls on each side of said disc include a third semi-circular wall perpendicular to said parallel semi-circular walls, said perpendicular semi-circular walls also having notches.

31. A wire mesh reinforcing structure including two wire mesh layers sandwiching a plurality of three-dimensional inclusions having notches for receiving individual wires of said wire mesh to align said inclusions.

32. A wire mesh reinforcing structure as claimed in claim 31, wherein said three-dimensional inclusions interlock with each other.

33. A wire mesh reinforcing structure as claimed in claim 32, wherein said three-dimensional inclusions have respective interlocking tongue and groove structures.

34. A wire mesh reinforcing structure as claimed in claim 33, further comprising openings for receiving rods that extend through rows of inclusions to further align said inclusions.

35. A three-dimensional, generally polyhedral reinforcement inclusion for UHPC and other applications, comprising:
three mutually perpendicular discs each having a least four cut-outs,
wherein said reinforcement inclusion defines spaces into which structures of other said reinforcement inclusions extend when placed together in a confined space, and through which a casting material can pass.

36. The three-dimensional, generally polyhedral reinforcement inclusion of claim 35, wherein a material of said structure is polypropylene.

37. The three-dimensional, generally polyhedral reinforcement inclusion of claim 35, wherein a material of said structure is compressible, such that when said inclusion is surrounded by cement and said cement has set, said structure exerts a restoring force on said surrounding material.

38. The three-dimensional, generally polyhedral reinforcement inclusion of claim 35, wherein said cut-outs are circular openings in said discs.

39. The three-dimensional, generally polyhedral reinforcement inclusion of claim 38, wherein said cut-outs in at least one of said discs extends to a perimeter of said disc.

40. The three-dimensional, generally polyhedral reinforcement inclusion of claim 39, wherein said cut-outs each extend to a perimeter of said discs to form an interlocking inclusion having three mutually perpendicular structures radially extending from a central hub or intersection of the radially extending structures, and a plurality of circumferential arc-shaped structures that serves as hooks or anchors for said inclusion.

41. The interlocking, generally polyhedral reinforcement inclusion of claim 40, wherein said radially-extending structures each terminates in four of the circumferential arc-shaped structures, each arc-shaped structure extending transversely from the radially-extending structures, wherein when viewed in cross-section, the projections have arc-shaped concave sides, while the circumferential arc-shaped structures have convex outer surfaces such that neighboring inclusions can hook into each other.

42. A three-dimensional reinforcing inclusion comprising a hollow spherical main body and a plurality of pins radially extending from the main body.

43. A three-dimensional reinforcing inclusion as claimed in claim 42, wherein said pins fit within openings in wire mesh layers on opposite sides of the said inclusion.

44. A three-dimensional reinforcing inclusion as claimed in claim 42, wherein a number of said pins is six, said pins extending along three mutually perpendicular axes.

45. A three-dimensional reinforcing inclusion for a concrete material, consisting of a wire formed into a plurality of loops.

46. A three-dimensional reinforcing inclusion as claimed in claim 45, wherein said loops are arranged in sets that extend in radially different directions from an axis of said wire.

47. A three-dimensional reinforcing inclusion as claimed in claim 45, wherein said wire is a hollow tube.

48. A three-dimensional reinforcing inclusion as claimed in claim 45, wherein said wire includes basalt fibers.

49. A three-dimensional reinforcing inclusion as claimed in claim 45, wherein said wire includes a plurality of fibers wrapped around a central core.

50. A three-dimensional reinforcing inclusion as claimed in claim 49, wherein said central core is made of steel and said fibers are basalt fibers.

51. A three-dimensional reinforcing inclusion as claimed in claim 49, wherein said central core is made of a plastic material and said fibers are steel or basalt fibers.

52. A three-dimensional reinforcing inclusion as claimed in claim 51, wherein said plastic material is arranged to burn away during a fire and thereby provide voids for steam to escape into to prevent spalling of a concrete material in which the inclusion is cast.

53. A three-dimensional reinforcing inclusion as claimed in claim 51, wherein said plastic material is partially melted into said fibers to hold shapes of said loops.

54. A three-dimensional reinforcing inclusion as claimed in claim 45, wherein said wire is a braided tube with a central core that dissolves in alkaline concrete laving a void for steam, a braided material of the wire being selected from steel, basalt, plastic and ceramic.

55. A three-dimensional reinforcing inclusion, comprising a disc having two semi-circular cut-outs that are bent to extend transversely to a principal plane of the disc.

56. A three-dimensional reinforcing inclusion as claimed in claim 55, wherein said disc further includes a plurality of holes to provide an enhanced anchoring effect when the inclusion is including in a cast material.

57. A method of casting a concrete structure, comprising the steps of:
providing a mold;
pouring a concrete material into the mold;
applying a vacuum to the concrete to draw air and moisture out of the concrete and thereby cure the concrete.

58. A method as claimed in claim 57, wherein the concrete is ultra high performance concrete (UHPC).

59. A method as claimed in claim 57, wherein the step of applying the vacuum to the concrete comprises the steps of sealing the mold within an airtight container and applying the vacuum to the air tight container.

60. A method as claimed in claim 57, wherein said vacuum is maintained by a seal and a check valve on the mold.

61. A method as claimed in claim. 57, further comprising the step of adding three-dimensional, generally polyhedral or spherical inclusions to the mold before pouring the concrete material into the mold.

62. A method as claimed in claim 61, wherein said inclusions are interlocking inclusions and the step of pouring the concrete material into the mold presses said inclusions against each other to cause them to interlock.

63. A method as claimed in claim 61, wherein the three dimensional inclusions are compressible, wherein the concrete material compresses the inclusions to provide a pre-load to the concrete.

64. A method as claimed in claim 61, wherein the three dimensional inclusions are compressible, and further comprising the step of applying pressure to the concrete material after pouring into the mold.

65. A structure made of a concrete material, comprising:
an inner structural layer; and
first and second layers sandwiching said inner structural layer,
wherein said first and second layers include interlocking three-dimensional generally-polyhedral molded plastic inclusions surrounded by a structural composite material.

66. A structure as claimed in claim 65, wherein at least
a plurality of said inclusions are each made up of:
at least one central disc-shaped or annular structure that forms a parting plane for an two-piece injection mold, and structures extending generally transversely from opposite sides of the central disc-shaped or annular structure to define a generally polyhedral shape,
wherein said inclusion includes spaces into which structures of other said inclusions extend when placed in a together in a confined space, and through which said structural composite material can pass.

67. A structure as claimed in claim 65, wherein said structural composite material is concrete.

68. A structure as claimed in claim 65, wherein said structural composite material is UHPC.

69. A structure as claimed in claim 65, wherein said inner structural layer is insulation, and said structure is low-cost earthquake or tornado proof housing.

70. A structure as claimed in claim 65, wherein said structure is a blast resistant structure for military applications.

71. A structure as claimed in claim 70, wherein said inner structural layer is a layer of an armored vehicle, a hull layer of a ship or submarine, or a concrete dock.

72. A structure as claimed in claim 71, wherein said structural composite material is a resin or fiberglass material.
